(19) United States
(12) Patent Application Publication
(10) Pub. No.: US 2026/0359894 A1
(43) Pub. Date: Nov. 12, 2026

(54) SYSTEMS AND METHODS FOR DETECTING EVENT OCCURRENCES TO TRIGGER USER ENGAGEMENT

(71) Applicant: The PNC Financial Services Group, Inc., Pittsburgh, PA (US)

(72) Inventors: Robert J. Schukai, Marietta, GA (US); Deanna N. Gilbert, Arlington Heights, IL (US); Minette Vaccariello, Pittsburgh, PA (US); Brianna K. Hogan, Coraopolis, PA (US); Melissa Morello, Pittsburgh, PA (US); Touseef Habib, Secaucus, NJ (US)

(73) Assignee: The PNC Financial Services Group, Inc., Pittsburgh, PA (US)

(21) Appl. No.: 19/667,998

(22) Filed: May 5, 2026

Related U.S. Application Data
(60) Provisional application No. 63/802,169, filed on May 8, 2025.

(51) Int. Cl. G06Q 40/06; G06Q 40/12

(52) U.S. Cl. CPC G06Q 40/06; G06Q 40/12

(57) ABSTRACT

A system is disclosed for generating personalized content. The system may include at least one processor configured to execute the instructions to perform operations. The operations may include receiving user data into a database from a data source; fulfilling a data retrieval request by communicatively coupling a data processing engine with the database; matching, using the data processing engine, user data from a first database with user data from a second database and recording the matched user data in an account; detecting, using a machine learning model, an occurrence of an atypical event in the matched user data, the machine learning model trained to recognize a variation in the matched user data over time; generating a message upon detection of the atypical event to prompt user engagement; and delivering the message to a user device.

### CROSS REFERENCE TO RELATED APPLICATIONS

This application claims priority from U.S. Provisional Application No. 63/802,169, filed on May 8, 2025, the entirety of which is incorporated by reference.

### BACKGROUND

Financial literacy is important but can be difficult to achieve. Users make money and spend money but may be uncertain whether they are taking adequate steps to maintain financial wellness. Becoming financially literate can be a great step towards financial wellness but may not be the right answer for everyone due to, for example, lack of time, lack of interest, or not knowing where to start. Institutions offer a variety of services, such as financial services, for their users. Many users use these services when they need to, but many users have minimal interaction with their accounts and may not keep in mind considerations for their long-term financial wellness.

Generally, institutions have specialists their users may speak with to help plan for their financial futures, brochures users may read with information about various financial products or strategies, and static online resources. Users may also learn from what their friends and family are doing and have told them. However, static resources may not address a specific user’s financial situation and may not have timely advice. Further, recommended actions and strategies may work for some users but not work for others. To promote and effectuate financial wellness, it may be important for users to interact with their finances in a frequent and timely manner and have a system for receiving timely and relevant financial advice. What is needed is a system for detecting atypical events in an account to trigger user engagement and provide timely and relevant suggestions to improve users’ financial wellness.

### SUMMARY

In view of the foregoing, embodiments of the present disclosure address disadvantages of existing conventional systems and methods by providing novel computer-implemented systems and methods for detecting atypical events in an account to trigger user engagement and provide timely and relevant suggestions to improve users’ financial wellness.

Embodiments of the present disclosure provide a computer implemented system for detecting atypical events in an account to trigger user engagement and provide timely and relevant suggestions to improve users’ financial wellness. The user engagement system may include a memory storing a set of instructions. The user engagement system may include a database in electronic communication with a memory. The user engagement system may include a processor in electronic communication with the database. The database may be configured to store information that includes corporate partner information, user information, and account and activity information. The information may be associated with a business or a business account. The user information may be associated with a user or an account. The account and activity information may be associated with at least one account. The processors may be configured to execute a set of instructions. The set of instructions may include receiving first user data into a first database from a first data source and second user data into a second database from a second data source; fulfilling a data retrieval request by communicatively coupling a data processing engine with the first database and the second database to: gather the first user data and the second user data for a period of time, combine the gathered first user data into a first data package and the gathered second user data into a second data package, and transmit the first data package and the second data package to the data processing engine; matching, using the data processing engine, the first user data from the first data package with the second user data from the second data package, the data processing engine configured to select a matching attribute, identify a candidate pair, and evaluate the candidate pair based on the matching attribute; recording the matched user data in an account based on the matching; detecting, using a machine learning model, an occurrence of an atypical event in the matched user data, the machine learning model trained, using historical matched user data, to recognize a variation in the matched user data over time, the training involving assessing the variation according to a predetermined variance criteria; generating a message upon detection of the atypical event to prompt user engagement; and delivering the message to a user device.

Aspects of the disclosed embodiments may include tangible computer readable media that store software instructions that, when executed by a processor, are configured for and capable of performing and executing a method, operation, and the like consistent with the disclosed embodiments. Also, aspects of the disclosed embodiments may be performed by a processor that is configured as special-purpose processor(s) based on software instructions that are programmed with logic and instructions that perform, when executed, an operation consistent with the disclosed embodiments.

Throughout this disclosure the phrase “disclosed embodiments” refers to examples of ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic. It is to be understood that both the foregoing general description and the following detailed description are exemplary and explanatory only, and are not restrictive of the disclosed embodiments, as claimed.

### BRIEF DESCRIPTION OF THE DRAWINGS

Embodiments and various aspects of the present disclosure are illustrated in the following detailed description and the accompanying figures. Various features shown in the figures are not drawn to scale. Identical reference numerals generally represent identical components in the exemplary implementations of the present disclosure.

FIG. 1 depicts an exemplary illustration of a user using a computing device to increase user engagement, consistent with disclosed embodiments.

FIG. 2 depicts an exemplary illustration of a user using a computing device to access an interactive user interface that provides users options about their finances, consistent with disclosed embodiments.

FIG. 3 depicts a block diagram showing an exemplary computing device, consistent with disclosed embodiments.

FIG. 4 depicts a flow chart for a method of detecting atypical events to trigger user engagement, consistent with disclosed embodiments.

FIG. 5 depicts a flow chart for a method of providing actionable next steps to trigger user engagement, consistent with disclosed embodiments.

FIG. 6 depicts a flow chart for a method of matching events with an outcome, consistent with disclosed embodiments.

FIG. 7 depicts a flow chart for a method of distinguishing options a user may engage with, consistent with disclosed embodiments.

FIG. 8 depicts a flow chart for a method of simulating outcomes of user options, consistent with disclosed embodiments.

FIG. 9 depicts a flow chart for a method of cross-platform user engagement, consistent with disclosed embodiments.

FIG. 10 depicts a flow chart for a method of promoting user engagement after detecting a break, consistent with disclosed embodiments.

FIG. 11 depicts a flow chart for a method of analyzing user engagement data, consistent with disclosed embodiments.

FIG. 12 depicts a flow chart for a method of recognizing a need, consistent with disclosed embodiments.

FIG. 13 depicts a flow chart for a method of identifying opportunity, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limiting.

Embodiments herein include computer-implemented methods, tangible non-transitory computer-readable media, and systems. The computer-implemented methods may be executed, for example, by a processor (e.g., a processing device) that receives instructions from a non-transitory computer-readable storage medium. Similarly, systems consistent with the present disclosure may include a processor (e.g., a processing device) and a memory, and the memory may include a non-transitory computer-readable storage medium. As used herein, a non-transitory computer-readable storage medium refers to any type of physical memory on which information or data readable by a processor may be stored. Examples include random access memory (RAM), read-only memory (ROM), volatile memory, non-volatile memory, hard drives, compact disc (CD) ROMs, digital optical discs (DVDs), flash drives, disks, and/or any other known physical storage medium. Singular terms, such as “memory” and “computer-readable storage medium,” may additionally refer to multiple structures, such as a plurality of memories and/or computer-readable storage mediums. As referred to herein, a “memory” may include any type of computer-readable storage medium unless otherwise specified. A computer-readable storage medium may store instructions for execution by a processor, including instructions for causing the processor to perform steps or stages consistent with an embodiment herein. Additionally, a computer readable storage medium may be utilized in implementing a computer-implemented method. The term “computer-readable storage medium” should be understood to include tangible items and exclude carrier waves and transient signals.

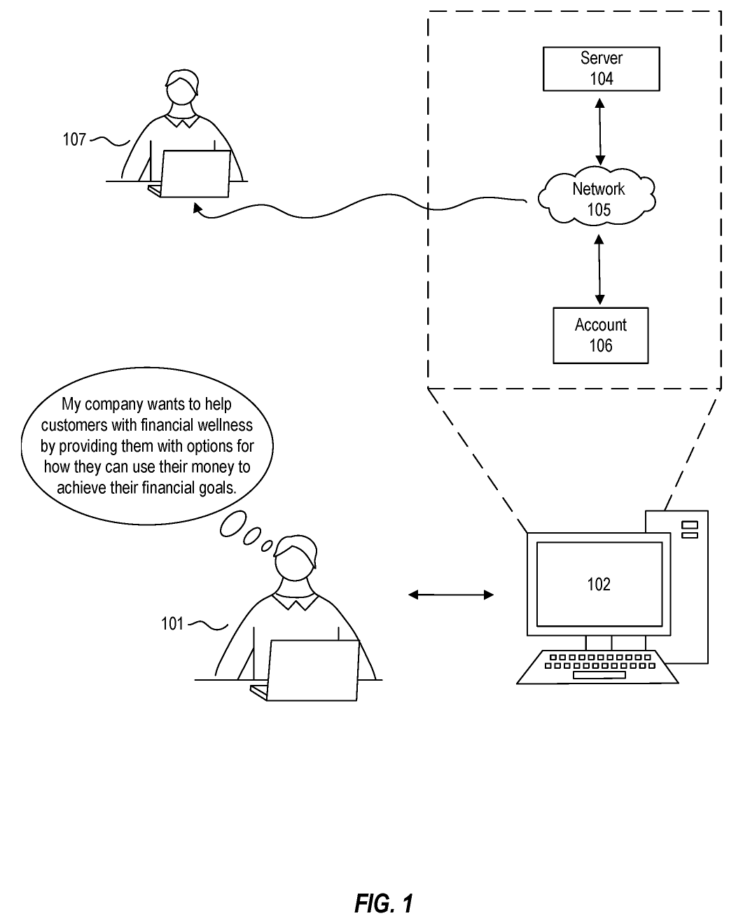

FIG. 1 depicts an exemplary illustration of user 101 using computer 102 to view account 106 associated with customer 107 to consider a state of the customer 107’s finances. User 101 considers: “My company wants to help customers with financial wellness by providing them with options for how they can use their money to achieve their financial goals.” User 101 may use the computer 102 to access account 106 and determine if customer 107 is on track to meet financial goals. User 101 may look into the customer 107’s spending, loan applications, income, recurring payments, investment portfolio, and usage of account features. Customer 107 may be knowledgeable about their finances and what they should do to improve or to meet their goads, or customer 107 may be unsure of what to do differently, if anything. An associate (which may or may not be user 101) at an institution, such as a financial institution, with which account 106 is associated may contact customer 107 to check in on customer 107’s performance and goals at regular intervals, such as annually. The associate may make note of any questions or concerns of customer 107 and of any unusual activity on account 106 and may share insights or resources with customer 107 to improve their financial health.

The exemplary illustration may include network 105, server 104, and account 106. User 101 may request or access customer 107’s financial information from server 104. Computer 102 may communicate and send data over network 105 and may store the determined risk of lending on server 104 or in account 106.

Account 106, as described herein, may refer to a record of information, such as financial information and transactions. Account 106 may also contain personal information about a user (such as customer 107), such as name and birthday or account information such as holdings, balances, when the account was opened, withdrawals, deposits, regular and irregular account activity, debts, automatic transaction settings, loans, payment history, and interest earned.

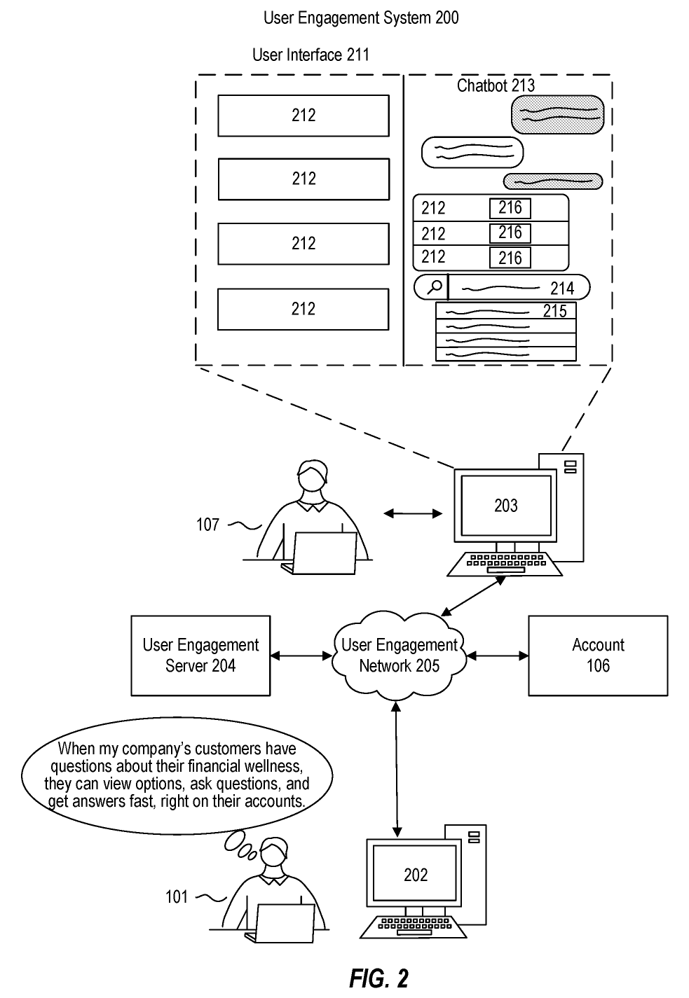

FIG. 2 depicts an exemplary illustration of user 101 using computing device 202 to access user interface 211 of user engagement system 200 that provides customer 107 with options about their finances via personal computing device 203. User 101 may consider: “When my company’s customers have questions about their financial wellness, they can view options, ask questions, and get answers fast, right on their account.” Customer 107 may use personal computing device 203 to view user engagement system 200. User engagement, as described herein, may refer to ongoing interactions and relationships an institution builds with its users. User engagement may include creating a positive and meaningful experience that encourages customer 107 to actively participate in and connect with the institution and its goods and services. User engagement system 200 may monitor account 106 for atypical events. Atypical events, as described herein, may refer to unusual activity that may be indicative of risk, need, or opportunity. Atypical events may include, for example, an unusually large deposit, an unusually large withdrawal, an unusually large payment, a substantial increase or decrease in the rate of savings, months that end with an account balance lower than at the start of the month, receiving a tax return, applying for a loan, or receiving a year-end bonus.

User engagement system 200 may detect atypical events by monitoring data streams, applying specific rules and patterns, utilizing machine learning models, implementing behavioral analysis, performing anomaly detection, or by some other detection mechanism. After user engagement system 200 detects an atypical event, it may assess the atypical event or a performance of account 106 to determine whether the atypical event relates to risk, need, opportunity, or some other characteristic. After assessing the atypical event, user engagement system 200 may generate a message that addresses the atypical event. Message, as described herein, may include suggestions regarding how to handle a situation or make an improvement, personalized options for actions that customer 107 may take in response to the atypical event, or feedback on how customer 107 is doing in terms of financial wellness. Messages sent by user engagement system 200 may be interactive, allowing customer 107 to engage with the message to learn more or initiate actions.

User engagement system 200 may include user engagement network 205, user engagement server 204, and account 106. Various components of user engagement system 200, including the computing device 202 and the personal computing device 203, may communicate over user engagement network 205. User engagement network 205, as described herein, may refer to an environments in which relevant activities of customer 107 on personal computing device 203 may be recorded and stored for future viewing. The recording, transmission, and storage of the recorded user activity may be performed in a secure manner, such that only the institution and customer 107 may have access to the recorded activity.

Such communications over user engagement network 205 may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, communications may take place across two or more of these forms of networks and protocols. In other embodiments, user engagement network 205 may also be a localized system, with components communicating directly with each other.

User engagement server 204, as described herein, may refer to a digital and/or analog device that allows communication with other machines and devices. The computing device 202, personal computing device 203, user engagement server 204, and account 106 may communicate with one another and to user 101 and/or customer 107 over user engagement network 205.

Customer 107 may use personal computing device 203 to explore user interface 211. Once user engagement system 200 generates personalized interactive option 212 addressing an atypical event, user engagement system 200 may deliver a message to a user device, such as personal computing device 203, where the message may appear on user interface 211. User interface 211, as described herein, may refer to a way for customer 107 to interact with personal computing device 203 or an application, including the visual elements, interactive features, and user controls. In some embodiments, user interface 211 may include buttons and icons and may be configured to interact with a touchscreen, a keyboard, a mouse, or monitors.

The message may appear as personalized interactive option 212. In some embodiments, personalized interactive option 212 may include a recommendation to apply for a new credit card that offers better rewards. In some embodiments, personalized interactive option 212 may include a recommendation to save, for example, $200 every month in the upcoming year to be able to afford a specific purchase by year end. In some embodiments, personalized interactive option 212 may include a recommendation to cancel unused subscriptions to save money each month. In some embodiments, personalized interactive option 212 may include a statement, for example, that individuals in a similar position as customer 107, who received a $10,000 bonus, spend $4,000 to pay down debt, put $2,000 in a college fund, invest $2,000 in mutual funds, and deposit $2,000 in their savings account. In some embodiments, personalized interactive option 212 may include a statement that certificate of deposit interest rates are at an all-time high and may include a recommendation that customer 107 may therefore wish to open a certificate of deposit. In some embodiments, personalized interactive option 212 may include a notification that customer 107 made a substantial purchase and that to continue their account’s average rate of growth, customer 107 should save, for example, $200 per week for the rest of the month. In some embodiments, personalized interactive option 212 may include a notification that the customer 107’s account balance dropped below a certain threshold, customer 107’s highest category of spending is dining out, and a recommendation that customer 107 dine out less. In another embodiment, personalized interactive option 212 may include a recommendation that customer 107 apply for a loan.

Customer 107 may engage with personalized interactive options 212 to learn more and decide which personalized interactive option 212 may be the best choice to address their atypical event. In some embodiments, customer 107 may select a personalized interactive option 212 and receive concrete steps to take related to a selected personalized interactive option 212. In some embodiments, customer 107 may select a personalized interactive option 212 and receive a request to initiate action towards carrying out the selected personalized interactive option 212.

Customer 107 may also initiate discussions with chatbot 213 by typing questions into text box 214. Customer 107 may ask chatbot 213 for advice about financial wellness, ask about their atypical event, ask what to do in hypothetical financial situations, ask what other people in customer 107’s situation have done, ask to predict the likely outcome of a certain action or transaction, or ask a question to improve their financial literacy. As customer 107 types in text box 214, a predicted suggestion 215 may appear adjacent to text box 214 for customer 107 to select from. In other embodiments, customer 107 may also attach photos or documents to text box 214 to send to chatbot 213. When chatbot 213 responds to the customer 107’s questions, chatbot 213 may provide textual responses, links to digital resources, or personalized interactive option 212. Personalized interactive option 212 may include an action button 216 for customer 107 to view concrete steps for proceeding with a personalized interactive option 212. In some embodiments, action button 216, may request permission from customer 107 to automatically take action according to personalized interactive option 212.

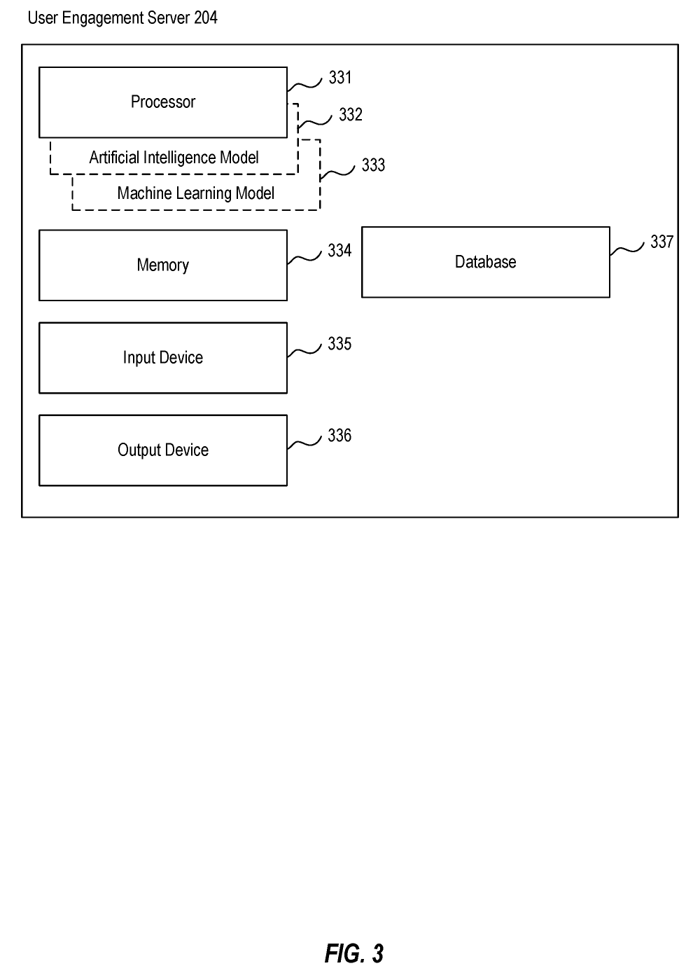

FIG. 3 depicts a block diagram showing an exemplary computational device, such as user engagement server 204, consistent with disclosed embodiments. User engagement server 204, as described with respect to FIG. 1, may include a dedicated processor and/or memory. For example, user engagement server 204 may include processor (or multiple processors) 331, and memory (or multiple memories) 334.

Processor 331 may take the form of, but is not limited to, a microprocessor, embedded processor, or the like, or may be integrated in a system on a chip (SoC). Furthermore, according to some embodiments, processor 331 may be from the family of processors manufactured by Intel®, AMD®, Qualcomm®, Apple®, NVIDIA®, or the like. Processor 331 may also be based on the ARM architecture, a mobile processor, or a graphics processing unit, etc. The disclosed embodiments are not limited to any one type of processor. Processor 331 may use an artificial intelligence model 332 and/or a machine learning model 333. Artificial intelligence model 332, as described herein, may refer to a computer program trained on data to recognize patterns and make decisions with no or minimal human programming beyond the initial programming of the model.

Machine learning model 333, as described herein, may refer to a set of instructions that enables a computing device to learn from data, make predictions and improve their performance overtime with no or minimal human programming beyond the initial programming of the model. Machine learning model 333 may refer to a model that can find patterns or make decisions from a dataset. Various machine learning models 333 may be implemented by analyzing aggregate account data to detect atypical events, recognize patterns in account data before and after an atypical event occurs, and generate personalized interactive messages to address the atypical events. In some embodiments, machine learning model 333 may be used to generate a data analysis algorithm trained to understand the user’s financial goals and generate advice or options to help the user reach those goals.

Machine learning model 333 may utilize several steps for operation. In some embodiments, machine learning model 333 may use a query system to draw in and ingest new data and preprocessing and transformation steps to clean, normalize, and transform data before storing it. In some embodiments, data may be stored indefinitely, while in other embodiments data be stored for a shorter period of time, such as for as long as the data is relevant. For example, customer data may be stored until a customer associated with the customer data ceases to be a customer. Machine learning model 333 may also use a monitoring operation to monitor data flow, detect anomalies, or ensure data optimization.

In some embodiments, machine learning model 333 may have a triggers for retraining. In one embodiment, ingestion of new data may trigger retraining or fine tuning of machine learning model 333. In some embodiments, machine learning model 333 may retrain itself through use of back propagation to make predictions and compare them to actual outcomes. In some embodiments, machine learning model 333 may be trained using historical data and may continuously adjust internal parameters. In some embodiments, machine learning model 333 may be validated using separate datasets to assess accuracy, precision, recall, and other metrics. In other embodiments, machine learning model 333 may be evaluated through cross-validation or confusion matrices. Machine learning model 333 may be able to output a variety of data including scores, classifications, or recommendations. Machine learning model 333 may be configured to accept a variety of inputs, including text, image, audio, time series inputs, categorical inputs, and numerical inputs. Machine learning model 333 may accept, for example, user data, matched user data, external data, matched external data, historical data, a user milestone, a performance, a change in performance, an account state, a personalized interactive option, an outcome, or a set of rules, as inputs.

Matched user data, as described herein, may be a type of user data. Matched user data may refer to user data that has been paired with other user data to tie the user to the data associated with the user or to tie data associated with the user to other data associated with the user. User data, as described herein, may refer to data relating to the user that is held by the institution and thus may be internal. User data may include information personally identifying information, such as name, date of birth, age, and address; transaction information, such as deposits, purchases, withdrawals, merchant information, date and time, location, and transaction type, such as automated teller machine withdrawal or credit/debit card purchase; account information, such as account number, account age, account balance, loan amounts, credit limits, and overdraft history; credit and risk information, such as credit score, repayment history, debt-to-income ratio, and collateral information; and behavioral and usage information, such as online banking login frequency, mobile application usage, and responses to marketing content. In some embodiments, user data may include information about the user that the user voluntarily provides to the institution.

Matched external data, as described herein, may be a type of external data. Matched external data may refer to external data that has been paired with user data to tie the user to the data associated with the user. Matched external data may also refer to external data that has been paired with other external data to tie data associated with the user to other data associated with the user. External data, as described herein, may refer to information that a third party, such as a merchant, investment institution, financial institution, educational institution, service provider, employer, or non-profit organization holds or has stored on an external platform related to the user. The external data may include information about the user and the user’s transactions or dealings with the third party. The external data may also include interaction data, such as user interaction data. Interaction data may include the method and frequency of the user interacting with the third party, with the external platform, or with a business in a network associated with an institution. For example, if the third party is a gambling service, the interaction data may include a size and frequency of bets, a subject of the bet, and whether the bet was placed online, over the phone, on a mobile application, or in a casino. In another example, if the third party is an investing institution, the interaction data may include the method and frequency at which the user logs into their account, purchase or sale of investments, or information about a user’s automated investment transactions.

In some embodiments, machine learning model 333 may be used to identify a pattern in the matched user data. In some embodiments, machine learning model 333 may be used to detect a change in performance resulting from an occurrence. In some embodiments, machine learning model 333 may be used to differentiate a first account state and a second account state. In some embodiments, machine learning model 333 may be used to determine a personalized interactive option. In some embodiments, machine learning model 333 may be used to recognize a performance trend. In some embodiments, machine learning model 333 may be used to identify a performance pattern.

For example, in some embodiments, machine learning model 333 may be used to detect an occurrence of an atypical event in the matched user data. An atypical event, as described with respect to FIG. 2, may be unusual activity that may be indicative of risk, need, or opportunity, such as an unusually large deposit, an unusually large withdrawal, an unusually large payment, a substantial increase in a rate of savings, a substantial decrease in a rate of savings, an account balance that is lower at the end of a month than it was at the start of the month, receiving a tax return, applying for a loan, or receiving a year-end bonus.

Machine learning model 333 may be trained in a variety of ways. For example, machine learning model 333 may be trained, using historical matched user data and/or historical atypical events, to recognize a variation indicating a historical atypical event in the historical matched user data over time. In some embodiments, the training may involve assessing the variation according to predetermined variance criteria. Predetermined variance criteria may be any static value a measured value is compared to for measuring how or if a measured value is different from what may be normal. For example, in some embodiments, the predetermined variance criteria may include how often may be normal or optimal for user activity or an event to occur during a period of time. In some embodiments, the predetermined variance criteria may include a percent growth or percent loss beyond which is atypical. In some embodiments, the predetermined variance criteria may include an account balance floor or an account balance ceiling. In some embodiments, the predetermined variance criteria may include a starting balance for a period of time.

In some embodiments, machine learning model 333 may be trained using historical matched user data. Machine learning model 333 may receive the matched user data, such as a user’s transactions, an account balance, or transfer history. Machine learning model 333 may be trained to recognize that the existence of variations in the matched user data is normal within certain bounds, but that substantial variations may be atypical and may require further attention. For example, machine learning model 333 may receive matched user data showing that the user has a monthly income of $6,000 but the user’s account balance on the first day of a month was $1,200 less than the account balance on the first day of the previous month, the user’s largest single deposit since they opened the account was $4,000 but the user recently deposited $12,000, and the user applied for a loan for the first time.

During training, machine learning model 333 may be trained that the matched user data involving some level of account growth may be normal and optimal, and therefore increases in an account balance month-over-month may be typical. Machine learning model 333 may be trained that account balances may not always increase but that a decrease in the value of an account of $500 or more may be atypical. For example, when the balance of an account associated with the user has a value on the first day of the month that is $1,200 less than the value of the account on the first day of the previous month, machine learning model 333 may be trained that, while account balances may not always increase, a decrease of $1,200 is more than $500 and therefore a substantial decrease. Machine learning model 333 may learn that substantial decreases in an account balance may be considered an atypical event. In some embodiments, machine learning model 333 may be trained that, as the user’s income increases, the size of the decrease in an account balance considered typical may decrease.

Similarly, machine learning model 333 may be trained that the matched user data involving deposits of a certain size, for example deposits of $5,000 or less, may be considered typical for the user. For example, when the user’s largest deposit since opening the account was $4,000, but the user recently deposited $12,000 into the account, machine learning model 333 may be trained that a deposit of $12,000 is more than $5,000 and therefore unusual for the user. Machine learning model 333 may learn that deposits of $12,000 are more than $5,000 and therefore an atypical event. In some embodiments, consistent deposits of more than $5,000 may train machine learning model 333 that deposits of greater than $5,000 are not unusual for the user. Machine learning model 333 may then raise the size of the deposit considered typical for the user.

Similarly, machine learning model 333 may be trained that the matched user data involving a user applying for a loan may be typical or atypical. Machine learning model 333 may be trained, for example, that the user applying for two loans during a ten-year period may be typical, but an application for the user’s first loan may be atypical. For example, when the user applied for one loan during a ten-year period, but application was the first loan application the user had ever submitted, machine learning model 333 may be trained to recognize that the user did not apply for more than two loans during the ten-year period, but the loan application is the user’s first. Machine learning model 333 may learn that, despite that the user may not submit more than two loan applications during the ten-year period, the user’s first loan application may always be atypical, so the user submitting the loan application may be an occurrence of an atypical event. In some embodiments, machine learning model 333 may learn that the number of loan applications considered typical may vary, for example, for different ages of the user.

Machine learning model 333 may learn from the examples and go through further training of receiving matched user data for a period and detecting an occurrence of the atypical event in the matched user data. For each set of matched user data, machine learning model 333 may assess the variation in the matched user data according to the predetermined variance criteria to detect an occurrence of the atypical event. The detection may then be confirmed or corrected until machine learning model 333 is able to make accurate detections a threshold amount of the time.

For example, machine learning model 333 may receive matched user data, which may include that the user’s account balance increased between $1,000 and $2,000 every month for the last six months, the user deposited $4,900 into their account, and the user submitted two loan applications during a ten-year period and one of the applications was the user’s first loan application. Machine learning model 333 may determine that the user’s account balance increasing between $1,000 to $2,000 every month for the last six months may indicate normal account activity of the account balance increasing each month. Machine learning model 333 may determine that an occurrence of an atypical event was not detected. Machine learning model 333 may be informed that its determination was correct and may continue training.

In another example, machine learning model 333 may determine that the user’s deposit of $4,900 into their account may be a deposit consistent in size to what is usual for the user because the user normally deposits $5,000 or less at a time. Machine learning model 333 may detect that the deposit is not an occurrence of an atypical event. Machine learning model 333 may be informed that its detection was correct and may continue training.

In another example, machine learning model 333 may determine that the user submitting two loan applications during a ten-year period, where the first application of the two applications was the user’s first loan application, may be unusual because the user submitted their first loan application. Machine learning model 333 may detect that the submission each of the first loan application and a second loan application in a ten-year period was an occurrence of an atypical event. Machine learning model 333 may be informed that its detection was only partially correct. Machine learning model 333 may be informed that submission of the first loan application may by an occurrence of an atypical event because the loan application is the user’s first loan application but may be informed that submission of the second loan application may not be an occurrence of an atypical event because the user did not submit more than two loan applications during the ten-year period. Machine learning model 333 may then continue training.

Machine learning model 333 may be configured to accept specific inputs. For example, machine learning model 333 may receive data such as user data, including matched user data. In some embodiments, machine learning model 333 may receive and detect an atypical event in other data, such as external data. Machine learning model 333 may receive the data, assess the data for variations, and detect whether there exists an occurrence of an atypical event.

Memory 334 may include a storage device configured to store instructions used by processor 331 to perform functions related to the computing device. The disclosed embodiments are not limited to software programs or devices configured to perform dedicated tasks. For example, memory 334 may store a single program, such as a user level application, which may perform the functions associated with the disclosed embodiments or may include multiple software programs. Additionally, processor 331 may, in some embodiments, execute one or more programs (or portions thereof) remotely located from user engagement server 204. Furthermore, memory 334 may include a storage device configured to store data for use by the programs. Memory 334 may include, but is not limited to, a hard drive, a solid-state drive, a CD-ROM drive, a peripheral storage device (e.g., an external hard drive, a USB drive, etc.), a network drive, a cloud storage device, or any other storage device.

User engagement server 204 may include a digital and/or analog device that allows communication with other machines and devices, such as other components of a user engagement system, as described with respect to FIG. 2. User engagement server 204 may include one or more input devices 335 or output devices 336. Input device 335 may be configured to receive input from the user and a component of server 204, which may perform a function in response to the input received. In some embodiments, input device 335 may include a user interface, as described with respect to FIG. 2, displayed on a touchscreen (e.g., an output device 336). Output device 336 may include a screen for displaying communications to the user. For example, output device 336 may include a display configured to display the information relating to the transaction. User engagement server 204 may include other components known in the art for interacting with a user. Output device 336 may also include digital and/or analog devices that allow the user to interact with the user engagement system, such as a touch sensitive area, keyboard, buttons, or microphones.

In some embodiments, user engagement server 204 may include database 337. Database 337 may be included on a volatile or non-volatile, magnetic, semiconductor, tape, optical, removable, non-removable, or other type of storage device or tangible or non-transitory computer-readable medium. Database 337 may also be part of user engagement server 204 or separate from user engagement server 204. When database 337 is not part of user engagement server 204, user engagement server 204 may exchange data with database 337 via a communication link. Database 337 may include a memory device that stores data and instructions used to perform a feature of the disclosed embodiments. Database 337 may include any suitable databases, ranging from small databases hosted on a workstation to large databases distributed among data centers. Database 337 may also include any combination of databases controlled by a memory controller device (e.g., server(s)) or software. For example, database 337 may include document management systems, Microsoft SQL™ databases, SharePoint™ databases, Oracle™ databases, Sybase™ databases, other relational databases, or non-relational databases, such as mongo and others.

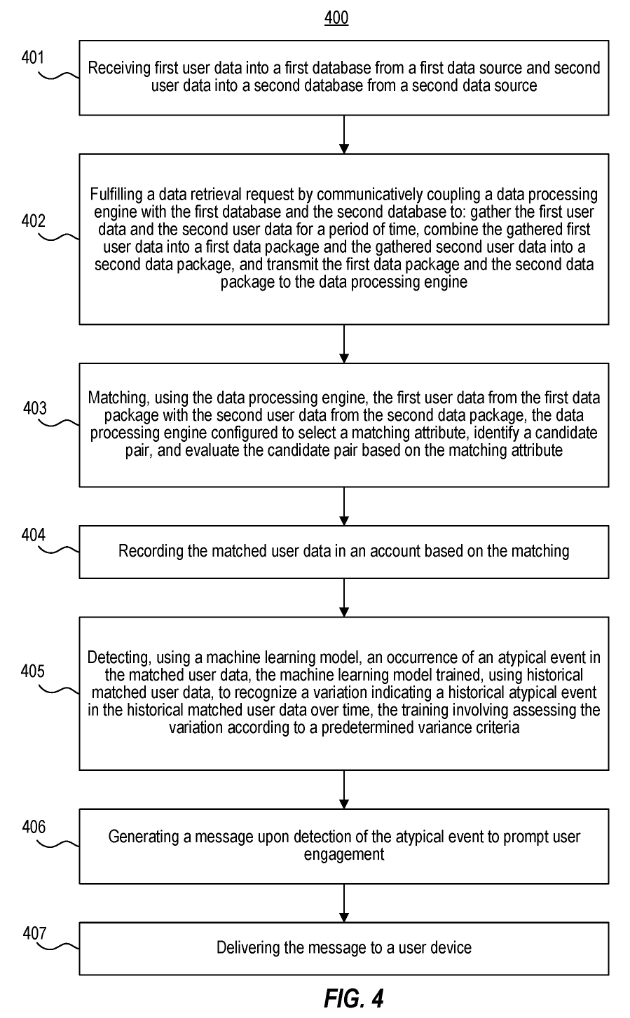

FIG. 4 depicts a flow chart for a method 400 of detecting atypical events to trigger user engagement. Some embodiments pertain to monitoring user activity and developing rules such that irregular activity triggers recommendations for how a user could use their money or improve their financial health. Such embodiments may involve a computer system, for example, at a bank or institution, that monitors user activity and develops rules such that irregular activity triggers recommendations for how a user could use their money or improve their financial health.

Method 400 may include a step 401 of receiving first user data into a first database from a first data source and second user data into a second database from a second data source. Each of the first database and the second database, as described herein, may correspond to database 337, as described with respect to FIG. 3. Both the first user data and the second user data, as described herein, may be user data, as described with respect to FIG. 3, from a data source. Data source, as described herein, may refer to an origin of data, such as user data or external data. In some embodiments, the data source may be, for example, a transaction record, an account, a user profile, a credit history, a customer relationship management program, a website analytics service, an external system, a third party platform, or a user-facing application. In some embodiments, the first data source and the second data source may each have their own database, such as the first database and the second database. In some embodiments, the first data source and the second data source may share a database. In some embodiments, other data, such as external data from an external platform, may be received into first database or a second database.

Method 400 may include a step 402 of fulfilling a data retrieval request by communicatively coupling a data processing engine with the first database and the second database. Data processing engine, as described herein, may refer to a software framework that may automate a processing of whole datasets or individual records. In some embodiments, the data processing engine may be an extract, transform, and load tool that may collect data from the first database and the second database, may configure how to process the first user data and the second user data, and may write the processed data as new or updated records. In some embodiments, communicatively coupling, as described herein, may involve connecting the data processing engine to the first database and the second database such that data may be exchanged between them. Communicative coupling may be achieved by, for example, direct connection or indirect connection, wired connection or wireless connection, local connection or remote connection, or one-way connection or two-way connection.

The data processing engine may be communicatively coupled to the first database and the second database to gather the first user data and the second user data for a period of time. In some embodiments, the period of time may be, for example, a day, a week, a month, a year, or some other period of time. The data processing engine may be communicatively coupled to the first database and the second database to combine the gathered first user data into a first data package and the gathered second user data into a second data package. In some embodiments, each of the first data package and the second data package, as described herein, may refer to a grouping of a smaller and/or individual data record. In some embodiments, the smaller and/or individual data record may include the first user data and the second user data. In some embodiments, the smaller and/or individual data record may include the gathered first user data and the gathered second user data. The smaller and/or individual data record may be combined into a larger, more compact format for efficient transmission, storage, or processing. The data processing engine may be communicatively coupled to the first database and the second database to transmit the first data package and the second data package to the data processing engine.

Method 400 may include a step 403 of matching, using the data processing engine, the first user data from the first data package with the second user data from the second data package. The data processing engine may be configured to select a matching attribute, identify a candidate pair, and evaluate the candidate pair. The evaluation may be based on the matching attribute. In some embodiments, the matching may involve identifying the matching attribute from the first user data in the first data package or from the second user data in the second data package. In some embodiments, identifying the matching attribute may involve selecting the first user data from the first data package or the second user data from the second data package. In some embodiments, identifying the matching attribute may then involve examining the selected first user data or the selected second user data for the matching attribute, which may be a user identifier, such as, for example, a name, contact information, account data, device data, customer identification number, account number, email address, phone number, login pattern, or account activity.

In some embodiments, identifying a candidate pair may involve selecting the first user data from the first data package and the second user data from the second data package that may each be a candidate for matching. Together, the first user data and the second user data may be the candidate pair. In some embodiments, two data records of the first user data from the first data package may be the candidate pair. In some embodiments, two data records of the second user data from the second data package may be the candidate pair. After the candidate pair is identified, the data processing engine may evaluate the candidate pair by, for example, selecting a matching attribute identified from the first user data and determining if the matching attribute may also be identified in the second user data. If the matching attribute may be identified in both the first user data and the second user data, then the candidate pair may match. In some embodiments, the match may tie the candidate pairs to a user, who may be a customer.

Method 400 may include a step 404 of recording the matched user data in an account based on the matching. In some embodiments, the matched user data may may be recorded in an account associated with the user based on the matching attribute being a user identifier.

Method 400 may include a step 405 of detecting, using a machine learning model, an occurrence of an atypical event in the matched user data, as described with respect to FIG. 2. In some embodiments, the atypical event may be a deposit that may be greater than a preselected growth threshold. For example, if a user’s deposits may typically range in value from $1 to $5,000, then the preselected growth threshold may be $5,000. So, a deposit of greater than $5,000 may be greater than the preselected growth threshold and therefore may be detected as an atypical event. In some embodiments, the preselected growth threshold may be greater than a top end of the range, such as, for example, $6,000. In some embodiments, the atypical event may be a withdrawal that may be greater than a preselected loss threshold. For example, if a user’s withdrawals may typically range in value from $1 to $200, then the preselected loss threshold may be $200. So, a withdrawal of greater than $200 may be greater than the preselected loss threshold and therefore may be detected as an atypical event.

In some embodiments, the atypical event may be a payment that may be greater than a preselected spend threshold. For example, if an amount the user spends on a single item may typically range from $1 to $150, then the preselected spend threshold may be $150. So, a purchase costing greater than $150 may be greater than the preselected spend threshold and therefore may be detected as an atypical event. In some embodiments, the atypical event may be a change in a savings rate that may be greater than a preselected savings threshold. For example, if 25% of a user’s paycheck typically is put towards the user’s savings, then the preselected savings threshold may be 25%. So, the user putting, for example, 30% of their paycheck towards savings may be greater than the preselected savings threshold and therefore may be detected as an atypical event.

In some embodiments, where the matched user data includes a first account balance and a second account balance, the atypical event may be the second account balance being less than the first account balance. In some embodiments, the atypical event may be classified as indicative of one of risk, need, or opportunity. The machine learning model may be trained, using historical matched user data, to recognize a variation indicating a historical atypical event in the historical matched user data over time. The training may involve assessing the variation according to a predetermined variance criteria. In some embodiments, the atypical event may be recorded in an atypical event log, and the atypical event log may be used to retrain the machine learning model.

Method 400 may include a step 406 of generating a message upon detection of the atypical event to prompt user engagement. In some embodiments, where the atypical event may be classified as indicative of one of risk, need, or opportunity, the message may be tailored based on the classification. Method 400 may include a step 407 of delivering the message to a user device.

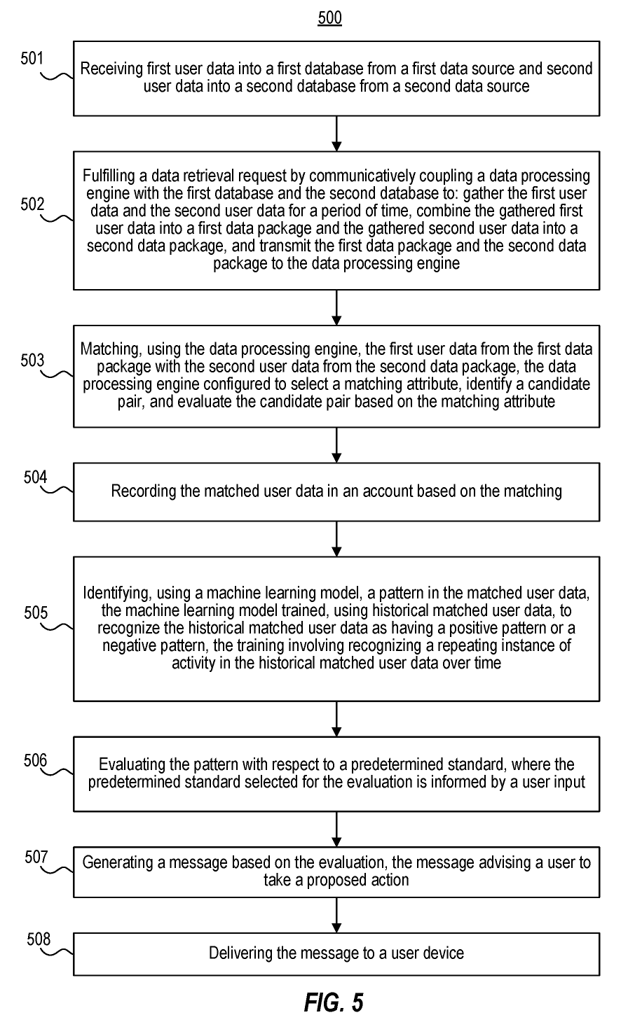

FIG. 5 depicts a flow chart for a method 500 of providing actionable next steps to trigger user engagement. Some embodiments pertain to providing users with “ready to act” options to give users concrete next steps or even initiate steps towards a specific option. An option may be a recommendation on how the user can improve their financial wellness. The recommendation may be directed to a financial mindset, strategy, action, inaction, or some other recommendation. Such embodiments may involve a computer system, for example, at a bank or institution, that provides users with “ready to act” options to give users concrete next steps or even initiate steps towards a specific option.

Method 500 may include a step 501 of receiving first user data into a first database from a first data source and second user data into a second database from a second data source, as described with respect to FIG. 4.

Method 500 may include a step 502 of fulfilling a data retrieval request by communicatively coupling a data processing engine with the first database and the second database, as described with respect to FIG. 4. The data processing engine may be communicatively coupled to the first database and the second database to gather the first user data and the second user data for a period of time. The data processing engine may be communicatively coupled to the first database and the second database to combine the gathered first user data into a first data package and the gathered second user data into a second data package. The data processing engine may be communicatively coupled to the first database and the second database to transmit the first data package and the second data package to the data processing engine.

Method 500 may include a step 503 of matching, using the data processing engine, the first user data from the first data package with the second user data from the second data package, as described with respect to FIG. 4. The data processing engine may be configured to select a matching attribute, identify a candidate pair, and evaluate the candidate pair. The evaluation may be based on the matching attribute. Method 500 may include a step 504 of recording the matched user data in an account based on the matching, as described with respect to FIG. 4.

Method 500 may include a step 505 of identifying, using a machine learning model, a pattern in the matched user data. The machine learning model may be trained, using historical matched user data, to recognize the historical matched user data as having a positive pattern or a negative pattern. The training may involve recognizing a repeating instance of activity in the historical matched user data over time. In some embodiments, the pattern may be a performance pattern. In some embodiments, the pattern may include an increase in a savings rate. In some embodiments, the increase in the savings rate may be evaluated with respect to a savings expectation. In some embodiments, the pattern may include a decrease in a savings rate. In some embodiments, the decrease in the savings rate may be evaluated with respect to a savings expectation. In some embodiments, the pattern may include that the user may be spending an increasing amount of money within a spending category, such as dining out or retail shopping. In some embodiments, the pattern may include that the user is spending more than their neighbors on electricity.

In some embodiments, the machine learning model may be trained using historical matched user data. The machine learning model may receive the matched user data, such as a user’s transactions, an account balance, or transfer history. The machine learning model may be trained to recognize the matched user data as having a positive pattern or a negative pattern by recognizing that some of the repeated instances of activity may be good for a user while other repeated instances may be harmful. In some embodiments, the machine learning model may be trained that some repeated instances are neither good nor harmful, but rather neutral. For example, the machine learning model may receive matched user data showing that, for four months in a row, the user put 5% more of a paycheck towards savings than a previous month and that the user spent less on groceries during a three month period and an increasing amount on dining out during the three month period.

During training, the machine learning model may be trained that the matched user data showing a fluctuation in savings each month may be normal and the fluctuations may not be indicative of a pattern. The machine learning model may also be trained that the matched user data showing the repeated activity over three months or more may be a pattern. The machine learning model may be trained that a percentage of a paycheck put towards savings may not always increase or decrease but that a consistency in the percentage or a consistent increase or decrease, for example, for three months or more may be a pattern. In some embodiments, the machine learning model may be further trained that consistency in the percentage or consistent increases in the percentage may be a positive pattern, consistent decreases in the percentage may be a negative pattern, and fluctuation in the percentage may be neutral. For example, when for four months in a row, the user put 5% more of a paycheck towards savings than a previous month, the machine learning model may be trained that increasing a percentage of the paycheck put towards savings by 5% each month for four months is a repeating instance of activity lasting three or more months and is a consistent increase in the percentage, so a positive pattern exists.

Similarly, the machine learning model may be trained that the matched user data showing a fluctuation in an amount spent in various spending categories may be normal and the fluctuations may not be indicative of a pattern. The machine learning model may also be trained that the matched user data showing the repeated activity over three months or more may be a pattern. The machine learning model may be trained that the amount spent in various spending categories may fluctuate but that a consistency increase or decrease in the amount spent in the spending category or an increase or decrease in the amount spent in the spending category, for example, for three months or more may be a pattern. For example, when the user spends less on groceries during the three month period and spends more on dining out during the three month period, the machine learning model may be trained that decreasing the amount of money spent on groceries and increasing the amount of money spent on dining out during the three month period is a repeating instance of activity lasting three or more months, so a pattern exists. The machine learning model may be further trained that a financial health of users who consistently dine in may generally be better than the financial health of users who consistently dine out. So, the machine learning model may be trained that spending less on groceries and spending more on dining out during a three month period is a negative pattern.

The machine learning model may learn from the examples and go through further training of receiving matched user data for a period and identifying a pattern in the matched user data and determining if the pattern is a positive pattern or a negative pattern. For each set of matched user data, the machine learning model may recognize the repeating instance of activity in the matched user data. The identification and recognition may then be confirmed or corrected until the machine learning model is able to make accurate detections a threshold amount of the time.

For example, the machine learning model may receive matched user data including that, for three months in a row, the user put 4% less of the paycheck towards savings each month for the three month period, and the user spent $600 more on retail shopping each month during the three month period than in previous months. The machine learning model may recognize that the user putting 4% less of the paycheck towards savings each month for the three month period may be a repeating instance of activity lasting three or more months and may identify the repeating instance of activity as a negative pattern. The machine learning model may be informed that its determination was correct and may continue training.

In another example, the machine learning model may recognize that the user spending $600 more on retail shopping each month during the three month period than in previous months may be a repeating instance of activity lasting three or more months and, since spending more money retail shopping reduced savings, may identify the repeating instance of activity as a negative pattern The machine learning model may be informed that its identification was correct and may continue training.

Method 500 may include a step 506 of evaluating the pattern with respect to a predetermined standard. In some embodiments, the predetermined standard selected for the evaluation may be informed by a user input. In some embodiments, the predetermined standard may be a baseline from which to tailor advice to the user. In some embodiments, the predetermined standard may be related to a user attribute in a user profile. In some embodiments, the user attribute may be, for example, a user age, location, savings, income, family situation, or goals. In some embodiments, the predetermined standard may be related to goals input by the user. In some embodiments, the predetermined standard may be related to an average financial state of like-users. For example, the evaluation may involve assessing the positive pattern of saving 30% of every paycheck with respect to the user being thirty years old, having a salary of $100,000, and users in a similar situation are saving, on average, 26% of every paycheck. In another example, the evaluation may involve assessing the negative pattern if the user spending 34% of their annual income on rent with respect to a market guideline that users should aim to spend no more than 25% of their annual income on rent.

Method 500 may include a step 507 of generating a message based on the evaluation. In some embodiments, the message may advise a user to take a proposed action. In some embodiments, the proposed action may include, for example, suggesting the user consider spending less on rent, spending less on retail shopping, spending more on groceries rather than on dining out, finding an apartment with a lower rent, changing auto insurance to a different provider, increasing a contribution to an investment account or a retirement account, remembering to turn a light or appliance off when leaving home, or increase a savings rate to a specific dollar amount or percentage. In some embodiments, the message may include a reminder or option for the user to update the user input. In some embodiments, the message may include a prompt to improve the evaluation based on a user attribute not yet associated with the user profile. For example, the evaluation my overlook or not consider a factor, which may be a predetermined standard or may be considering a wrong factor. For example, in the above example, while the user spends 34% of their annual income on rent, the user may be sharing the rent with a roommate or a spouse that the evaluation may not be considering as a predetermined standard. In some embodiments, the message may include an option to automatically execute the proposed action. In some embodiments, the message may include a proposed goal. Method 500 may include a step 508 of delivering the message to a user device.

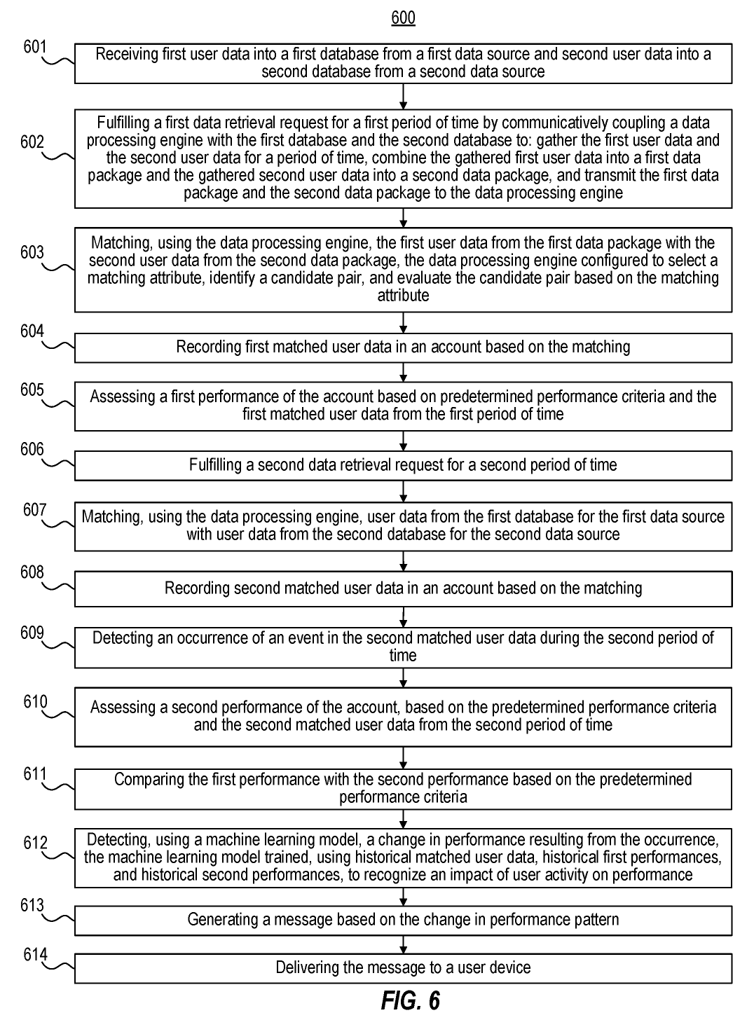

FIG. 6 depicts a flow chart for a method 600 of matching events with an outcome. Some embodiments pertain to a machine learning model that learns what various financial events may mean for a user’s financial wellness, learns the opportunities or risks likely to follow the event, and makes suggestions for the user to consider based on the event. Such embodiments may involve a computer system, for example, at a bank or institution, that uses a machine learning model to learn what various financial events may mean for a user’s financial wellness, learns the opportunities or risks likely to follow the event, and makes suggestions for the user to consider based on the event.

Method 600 may include a step 601 of receiving first user data into a first database from a first data source and second user data into a second database from a second data source, as described with respect to FIG. 4.

Method 600 may include a step 602 of fulfilling a first data retrieval request for a first period of time by communicatively coupling a data processing engine with the first database and the second database, as described with respect to FIG. 4. The data processing engine may be communicatively coupled to the first database and the second database to gather the first user data and the second user data for a period of time. The data processing engine may be communicatively coupled to the first database and the second database to combine the gathered first user data into a first data package and the gathered second user data into a second data package. The data processing engine may be communicatively coupled to the first database and the second database to transmit the first data package and the second data package to the data processing engine.

Method 600 may include a step 603 of matching, using the data processing engine, the first user data from the first data package with the second user data from the second data package, as described with respect to FIG. 4. The data processing engine may be configured to select a matching attribute, identify a candidate pair, and evaluate the candidate pair. The evaluation may be based on the matching attribute. Method 600 may include a step 604 of recording first matched user data in an account based on the matching, as described with respect to FIG. 4.

Method 600 may include a step 605 of assessing a first performance of the account. The assessment of the first performance may be based on predetermined performance criteria and the first matched user data from the first period of time. In some embodiments, the predetermined performance criteria, as described herein, may include, for example, a current account balance, an average account balance, a minimum balance, an inflow-to-outflow ratio, an occurrence of fee events or adjustments, an account status change, a volatility of balance changes, a frequency of transactions, an overdraft occurrence, an account age, and/or a period of inactivity. In some embodiments, the first matched user data may include, for example, transaction data or interaction data. In some embodiments, the period of time may be, for example, one month or one year. In some embodiments, the assessment may be limited to one of the predetermined performance criteria. In some embodiments, the assessment may involve assessment of more than one of the predetermined performance criteria. For example, the assessment may involve assessing a minimum balance. The user’s account may have restrictions on minimum account balances or require at least a minimum balance of, for example, $500 to avoid a penalty. The predetermined performance criteria may include a minimum account balance of $500. The assessment may involve verifying whether the user’s minimum account balance has been less than $500 or the assessment may involve a comparison of the predetermined performance criteria’s minimum account balance and the user’s minimum account balance.

Method 600 may include a step 606 of fulfilling a second data retrieval request for a second period of time, as described with respect to FIG. 4. Method 600 may include a step 607 of matching, using the data processing engine, user data from the first database for the first data source with user data from the second database for the second data source, as described with respect to FIG. 4. Method 600 may include a step 608 of recording second matched user data in the account based on the matching, as described with respect to FIG. 4.

Method 600 may include a step 609 of detecting an occurrence of an event in the second matched user data during the second period of time. In some embodiments, the event may be, for example, a deposit of funds having a value greater than a growth threshold, a withdrawal of funds having a value greater than a loss threshold, a single payment having a cost greater than a spend threshold, a submission of a loan application, an income raise, a loss of employment, an increase of a credit limit, an end-of-year bonus being paid to an account, a tax filing and a tax debt, a late credit card payment, or an overdraft. Detecting the occurrence of the event may involve gathering and analyzing the second matched user data for the period of time. Detecting may involve performing a keyword search or database query on the second matched user data for the period of time. In some embodiments, the second matched user data may be filtered based on a time constraint or based on relevance.

Method 600 may include a step 610 of assessing a second performance of the account. The assessment of the second performance may be based on the predetermined performance criteria and the second matched user data from the second period of time. In some embodiments, the first period of time and the second period of time may be consecutive. In some embodiments, the first period of time and the second period of time may each be one month.

Method 600 may include a step 611 of comparing the first performance with the second performance. The comparison may be based on the predetermined performance criteria. For example, if the predetermined performance criteria relates to the inflow-to-outflow ratio, then the comparison may be based on the inflow-to-outflow ratio of the first performance and the second performance. In some embodiments, comparing the first performance with the second performance may result in a comparison score. In some embodiments, the comparison score may be one of either a positive number or a negative number. In some embodiments, the comparison score may be determined by dividing the first performance by the second performance to determine how different the first performance and the second performance are. In some embodiments, the comparison score may be determined by subtracting the first performance from the second performance to determine how different the first performance and the second performance are.

Method 600 may include a step 612 of detecting, using a machine learning model, a change in performance resulting from the occurrence. The machine learning model may be trained, using historical matched user data, historical first performances, and historical second performances, to recognize an impact of user activity on performance.

In some embodiments, the machine learning model may be trained using historical matched user data. The machine learning model may receive the matched user data, such as a user’s transactions, an account balance, or transfer history. The machine learning model may be trained to recognize an impact of user activity and/or an occurrence on performance. The machine learning model may be trained that fluctuation of account performance from the first period of time to the second period of time may be normal but that the occurrence of the event, as detected in the second matched user data, may cause the change in performance, which may be a larger change in performance than what may be considered normal. For example, the machine learning model may receive second matched user data showing that after the user received a promotion and the income raise, the user’s credit limit increased; and after filing the user’s taxes, the user received notice of their tax debt.

During training, the machine learning model may be trained that the matched user data showing that after the user received the promotion and the income raise, the user’s credit limit increased demonstrates that after the occurrence of the event of the promotion and income raise, the user’s credit limit increased. The machine learning model may recognize that credit limits may generally increase as the user’s income increases, a credit utilization ratio may decrease when a credit limit increases and spending remains constant, a credit score may generally increase when the credit utilization ratio decreases, and account performance may change when the credit score increases. Thus, the machine learning model may learn to detect the change in performance of an increased credit score as a result of the occurrence of the promotion and the income raise.

Similarly, the machine learning model may be trained that the matched user data showing a change in an account after the occurrence may be indicative of the change in performance resulting from the occurrence. For example, when after filing the user’s taxes, the user received notice of their tax debt, the machine learning may be trained to recognize that the tax debt may result in the user paying additional taxes with money they may have reserved for other purposes. The machine learning model may detect that paying unexpected sums of money to satisfy a tax burden may impact the account performance, so the machine learning model may therefore detect a change in performance, such as a decrease in account balance, resulting from the occurrence of the tax filing.

The machine learning model may learn from the examples and go through further training of receiving matched user data for a period and detecting a change in performance resulting from the occurrence. For each set of matched user data, the machine learning model may recognize an impact of the matched user data, which may be related to user activity, on performance. The identification and recognition may then be confirmed or corrected until the machine learning model is able to make accurate detections a threshold amount of the time.

For example, the machine learning model may receive matched user data including that, after the user experienced a loss of employment, the user’s savings rate decreased, and after the user was paid the end-of-year bonus, the user’s account balance increased. The machine learning model may recognize that the loss of employment may lead to a loss of income, and the loss of income may result in challenges related to saving, which may affect account performance. The machine learning model may detect that a decrease in the savings rate is the change in performance resulting from the occurrence of the user experiencing the loss of employment. The machine learning model may be informed that its determination was correct and may continue training.

In another example, the machine learning model may recognize that the increase in the account balance may be an increase in income, and an increase in income may help the user to achieve a savings goal and improve account performance. The machine learning model may detect that the increase in the account balance is the change in performance resulting from the occurrence of the user receiving a year-end bonus. The machine learning model may be informed that its determination was correct and may continue training. In some embodiments, the change in performance may be recorded in a performance log.

Method 600 may include a step 613 of generating a message based on the change in performance. In some embodiments, the comparison score may be included in the message as a quantitative measure of the change in performance. In some embodiments, the comparison score may advise of the areas where the user may be excelling and the areas where the user may need to improve. For example, in some embodiments, the message may include a first comparison score indicating a first difference between the balance of the account after the second period of time and the balance of the account after the first period of time and/or a second comparison score indicating a second difference between an average monthly credit card balance during the second period of time and the average monthly credit card balance during the first period of time. For example, the first comparison may be +$12,000, indicating the account balance increased, and the second comparison score may be +$5,000, indicating the average monthly credit card balance increased during the second period of time. The comparison score may advise that the user’s account balance may continue to rise but that, with the user’s average expenses also rising, the user may be saving less than they would without rising expenses.

In some embodiments, the message may include an update on a financial wellness status following the occurrence. For example, the message may include an update that, based on the change in performance resulting from the occurrence, the user is more or less financially well-off after the occurrence than before the occurrence. In some embodiments, the message may include a portion of or the entire performance log to track how the user’s account performance changed since opening the account. Method 600 may include a step 614 of delivering the message to a user device.

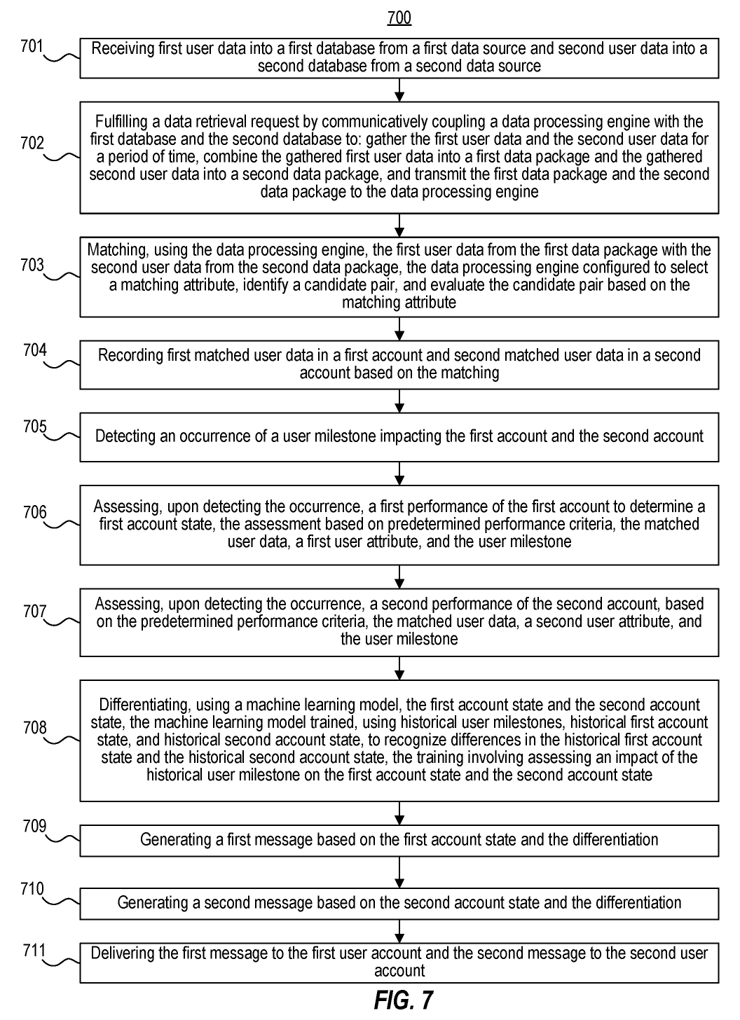

FIG. 7 depicts a flow chart for a method 700 of distinguishing options a user may engage with. Some embodiments pertain to a machine learning model that learns and teaches that what is financially good for one user may not be good for another user. Such embodiments may involve a computer system, for example, at a bank or institution, that uses a machine learning model to learn and teach that what is financially good for one user may not be good for another user.

Method 700 may include a step 701 of receiving first user data into a first database from a first data source and second user data into a second database from a second data source, as described with respect to FIG. 4.

Method 700 may include a step 702 of fulfilling a data retrieval request by communicatively coupling a data processing engine with the first database and the second database, as described with respect to FIG. 4. The data processing engine may be communicatively coupled to the first database and the second database to gather the first user data and the second user data for a period of time. The data processing engine may be communicatively coupled to the first database and the second database to combine the gathered first user data into a first data package and the gathered second user data into a second data package. The data processing engine may be communicatively coupled to the first database and the second database to transmit the first data package and the second data package to the data processing engine.

Method 700 may include a step 703 of matching, using the data processing engine, the first user data from the first data package with the second user data from the second data package, as described with respect to FIG. 4. The data processing engine may be configured to select a matching attribute, identify a candidate pair, and evaluate the candidate pair. The evaluation may be based on the matching attribute. Method 700 may include a step 704 of recording first matched user data in a first account and second matched user data in a second account based on the matching, as described with respect to FIG. 4.

Method 700 may include a step 705 of detecting an occurrence of a user milestone impacting the first account and the second account. User milestone, as described herein, may include, for example, a retirement, a debt, a loan, a deposit having a value greater than a threshold, a home purchase, a savings goal being reached, a job loss, a college graduation, or an age. Detecting the occurrence of the user milestone may involve gathering and analyzing the first matched user data and the second matched user data. Detecting may involve performing a keyword search or database query on the first matched user data and the second matched user data. In some embodiments, the first matched user data and the second matched user data may be filtered based on a time constraint or based on relevance. Method 700 may include a step 706 of assessing, upon detecting the occurrence, a first performance of the first account to determine a first account state, as described with respect to FIG. 6. Account state, including the first account state and a second account state, as described herein, may refer to a condition of the account after the occurrence of the user milestone. The account state may make note of any changes resulting from the occurrence of the user milestone, such as changes in an account performance, a requirement, an eligibility, a contribution limit, a distribution, an interest rate, or a control. The assessment of the first performance may be based on predetermined performance criteria, the matched user data, a first user attribute, and the user milestone. Method 700 may include a step 707 of assessing, upon detecting the occurrence, a second performance of the second account to determine the second account state, as described with respect to FIG. 6. The assessment of the second performance may be based on the predetermined performance criteria, the matched user data, a second user attribute, and the user milestone. In some embodiments, the first account state may be different than a second account state. In some embodiments, the first account state may relate to the condition of the first account associated with a first user. In some embodiments, the second account state may relate to the condition of the second account associated with a second user.

Method 700 may include a step 708 of differentiating, using a machine learning model, the first account state and the second account state. The machine learning model may be trained, using historical user milestones, historical first account state, and historical second account state, to recognize differences in the historical first account state and the historical second account state. The training may involve assessing an impact of the historical user milestone on the first account state and the second account state.

In some embodiments, the machine learning model may be trained using historical user milestones, the historical first account state, and the historical second account state. The machine learning model may receive the user milestones, the first account state, and the second account state, and the machine learning model may be trained to recognize differences in the first account state and the second account state. The machine learning model may be trained that, while a first account and a second account may both be impacted by the same user milestone or a similar user milestone, the first account and the second account may nonetheless be affected differently and/or may benefit from different solutions. For example, the machine learning model may receive the user milestone that the first user and the second user graduated from college and are starting their first jobs in one week, the first account state showing that a first user has $30,000 in savings and no loans, and the second account state showing that a second user has $11,000 in savings and $60,000 in loans to repay. In another example, the machine learning model may receive the user milestone that the first user and the second user both excelled at work and received $20,000 end-of-year bonuses, the first account state showing that a first user is single, and the second account state showing that a second user has a spouse and two children.

During training, the machine learning model may be trained that graduating from college and starting a first job may be a shared experience between the first user and the second user, but that the first account state of having $30,000 in savings and no loans to repay and the second account state of having $11,000 in savings and $60,000 in loans to repay may put the first user and the second user in two different positions. The machine learning model may learn that, going into the first job, the first user may have different priorities than the second user. The first user may, for example, be further along in saving to purchase a home than the second user, may be able to contribute to a retirement account or an investment account more easily or more aggressively than the second user, and may have more flexibility to make unnecessary or discretionary purchases than the second user. On the other hand, the second user may prioritize repaying their loans or may decide the interest rate on the loans is low and they may prioritize other financial activity. Thus, the machine learning model may differentiate the first account state and the second account state despite the first user and the second user experiencing the same user milestone. The machine learning model may learn that, because of the differences in the first account state and the second account state, the first user and the second user may be impacted differently by the user milestone.

Similarly, the machine learning model may be trained that excelling at work and receiving a $20,000 end-of-year bonus may be a shared experience between the first user and the second user, but that the first account state of the first user being single and the second account state of the second user having a spouse and two children may put the first user and the second user in two different positions. The machine learning model may learn that, after receiving the end-of-year bonus, the first user may have different priorities than the second user. The first user may, for example, use the bonus as part of a down payment for a home, contribute to investment accounts, repay student loans, or save the money to take a vacation. The second user may still use the end-of-year bonus for some of the same things as the first user, but the second user may also use the money from the bonus, for example, to help pay for childcare expenses, day-to-day expenses, or an anniversary present. Thus, the machine learning model may differentiate the first account state and the second account state despite the first user and the second user experiencing the same user milestone. The machine learning model may learn that, because of the differences in the first account state and the second account state, the first user and the second user may be impacted differently by the user milestone.

The machine learning model may learn from the examples and go through further training of receiving the first account state and the second account state and differentiating the first account state and the second account state. For each set of account states, the machine learning model may recognize differences in the account states and that the account states may be impacted differently by the user milestone. The differentiation and the recognition may then be confirmed or corrected until the machine learning model is able to make accurate differentiations a threshold amount of the time.

For example, the machine learning model may receive the user milestone that a first user and a second user lost their jobs, the first account state may show that the first user is 28 years old and has $100,000 in savings, and the second account state may show that the second user is 59 years old and has $450,000 in savings. The machine learning model may distinguish the first account state and the second account state based on the difference in age between the first user and the second user and the difference in savings. The machine learning model may determine that, while the first user and the second user both have enough money saved to live on while searching for other jobs, the first user may consider, for example, going back to school, changing career paths, moving to a new city, or taking time for themselves before starting a new job, but the second user may be more established and may, for example, consider retiring early or finding a part time job. The machine learning model may conclude that the second user may be relatively less likely to find a new career path. The machine learning model may be informed that its differentiation may be correct, and the machine learning model may continue training.

In another example, the machine learning model may receive the user milestone that a first user and the second user are retiring, the first account state may show that the first user has $1,400,000 in their retirement account, and the second account state may show that the second user has $500,000 in their retirement account. The machine learning model may determine that the first account state and the second account state are substantially similar after the user milestone. The machine learning model may be informed that its differentiation may be incorrect. The machine learning model may be corrected and trained that, while the first user and the second user are both retiring, the first user and the second user may be able to support different lifestyles in retirement. The machine learning model may determine that the first user may, for example, be able to delay social security, be more flexible with their distributions, handle unexpected expenses with ease, and have more latitude to downshift spending more gradually, but the second user may, for example, have difficulty covering unexpected expenses, rely on social security and required distributions, and have less flexibility in spending. The machine learning model may then continue training.

Method 700 may include a step 709 of generating a first message based on the first account state and the differentiation. Method 700 may include a step 710 of generating a second message based on the second account state and the differentiation. In some embodiments, the first message may be different from the second message. In some embodiments, the first message may advise why the first message may contain a first recommended action that may be different from a second recommended action in the second message. In some embodiments, the first message may include a list of possible actions and the first recommended action, which may be from the list of possible actions. In some embodiments, the second message may include the list of possible actions and the second recommended action, which may be from the list of possible actions. In some embodiments, the first recommended action may be different from the second recommended action. In some embodiments, the first recommended action may be different from the second recommended action because the first account state may be different from the second account state. Method 700 may include a step 711 of delivering the first message to the first user account and the second message to the second user account.

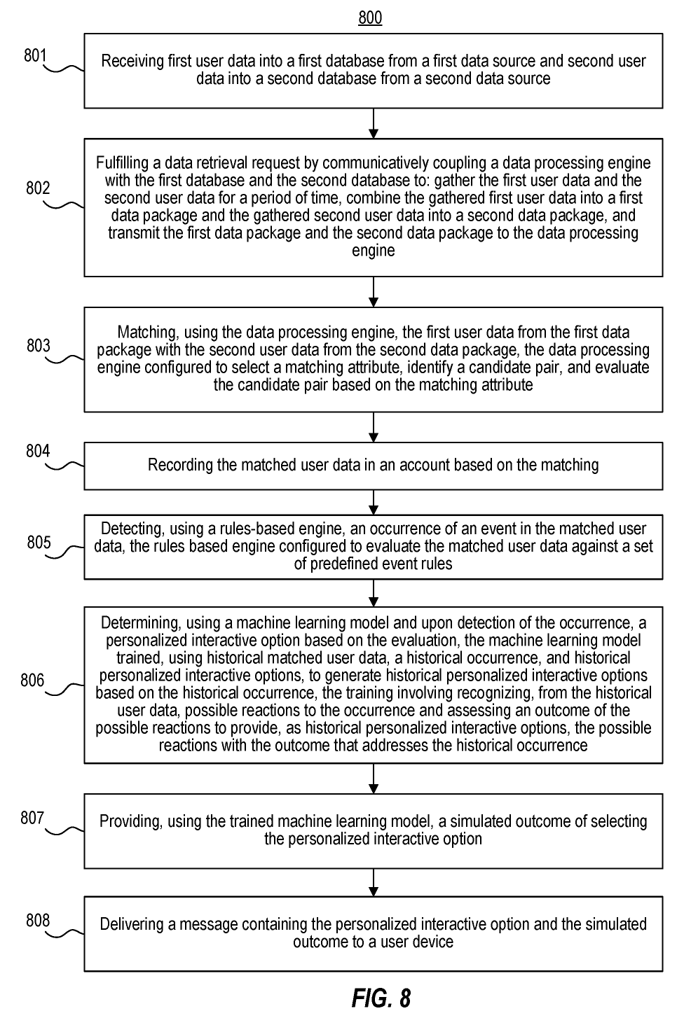

FIG. 8 depicts a flow chart for a method 800 of simulating outcomes of user options. Some embodiments pertain to a machine learning model that simulates financial outcomes of possible options for users choosing between options. Such embodiments may involve a computer system, for example, at a bank or institution, that uses a machine learning model to simulate financial outcomes of possible options for users choosing between options.

Method 800 may include a step 801 of receiving first user data into a first database from a first data source and second user data into a second database from a second data source, as described with respect to FIG. 4.

Method 800 may include a step 802 of fulfilling a data retrieval request by communicatively coupling a data processing engine with the first database and the second database, as described with respect to FIG. 4. The data processing engine may be communicatively coupled to the first database and the second database to gather the first user data and the second user data for a period of time. The data processing engine may communicatively be coupled to the first database and the second database to combine the gathered first user data into a first data package and the gathered second user data into a second data package. The data processing engine may be communicatively coupled to the first database and the second database to transmit the first data package and the second data package to the data processing engine.

Method 800 may include a step 803 of matching, using the data processing engine, the first user data from the first data package with the second user data from the second data package, as described with respect to FIG. 4. The data processing engine may be configured to select a matching attribute, identify a candidate pair, and evaluate the candidate pair. The evaluation may be based on the matching attribute. Method 800 may include a step 804 of recording the matched user data in an account based on the matching, as described with respect to FIG. 4.

Method 800 may include a step 805 of detecting, using a rules-based engine, an occurrence of an event in the matched user data. The rules-based engine may be configured to evaluate the matched user data against a set of predefined event rules. In some embodiments, the predefined event rules may involve applying if-then logic or Boolean logic to the matched user data to automate detection of events in the matched user data. In some embodiments, the predefined event rules may include rules related to an account age, account balance, a period of time, a user attribute, a transaction, a transfer amount or frequency, or a deposit or withdrawal amount. For example, the rules-based engine may check if a user is older than a given age, if an account is older than a given age, if the user got married, if the user had a child, if a deposit is greater than a first threshold, if a withdrawal is greater than a second threshold, if the user paid off a loan, if the user started using a new credit card, if a user’s check bounced, if the user’s income has increased or decreased, or if a user achieved their savings goal.

Method 800 may include a step 806 of determining, using a machine learning model and upon detection of the occurrence, a personalized interactive option based on the evaluation. The machine learning model may be trained, using historical matched user data, a historical occurrence, and historical personalized interactive options, to generate historical personalized interactive options based on the historical occurrence. The training may involve recognizing, from the historical matched user data, possible reactions to the historical occurrence and assessing an outcome of the possible reactions to provide, as historical personalized interactive options, the possible reactions with the outcome that addresses the historical occurrence.

In some embodiments, the machine learning model may be trained using the historical matched user data, the historical occurrence, and the historical personalized interactive options to generate personalized interactive options by recognizing possible reactions to the occurrence and the likely outcome of the possible reactions. The machine learning model may be trained that, after the occurrence of an event, the user may not know which possible reactions are available to them. Alternatively, the user may be aware of some possible reactions but may be unsure of what outcomes those possible reactions may have or may be unsure of how to know which possible reaction is suited to the user’s goals and circumstances. For example, the machine learning model may receive the occurrences of the user finishing paying off their student loans and that the user turned 50 years old.

During training, the machine learning model may be trained that the occurrence of the user finishing paying off their student loans may have several possible reactions. The machine learning model may recognize that the user may have been paying $800 per month to pay off their student loans. The machine learning model may then recognize that the user may now have several options for how they may use the extra $800 each month. The machine learning model may recognize that the user may use the money to pay off their auto loan, contribute to an investment account, contribute to a retirement account, pay for repairs on their rental property, or pay rent. The machine learning model may then consider which of the possible reactions match the user’s goals and/or life circumstances and may then generate a personalized interactive option for those reactions. For example, the machine learning model may recognize that those possible reactions to the user finishing paying off their student loans may be for the user to make repairs on their rental property to maintain its condition and attract tenants, pay their own rent because the user paid their rent late the last two months, and contribute to a retirement account. Thus, the machine learning model may learn to recognize possible reactions to the occurrence and present the user with the reactions chosen from the list of possible reactions based on which reactions match the user’s goals and/or life circumstances.

Similarly, the machine learning model may be trained that that the occurrence of the user finishing paying off their student loans may have several possible reactions. For example, the user may do nothing, continue their current course of action, contribute to an investment account, or take advantage of catch-up contributions for their 401k and/or individual retirement account (IRA). The machine learning model may then consider which of the possible reactions to present to the user and may then generate a personalized interactive option for each of those reactions. For example, the machine learning model may recognize that two possible reactions for the user turning 50 years old may be for the user to take advantage of catch-up contributions for their 401k and for their IRA because the user did not max out their contributions earlier in their career. Thus, the machine learning model may learn to recognize possible reactions to the occurrence and present the user with reactions suited to the user’s goals and circumstances.

The machine learning model may learn from the examples and go through further training of receiving the occurrence and matched user data for a period, recognizing possible reactions to the occurrence, and assessing the possible reactions to determine which addresses the occurrence. For each occurrence, the machine learning model may recognize the possible reactions, assess the possible reactions, and generate, from the possible reactions, personalized interactive options to present to the user. The recognition and generation may then be confirmed or corrected until the machine learning model is able to make accurate determinations a threshold amount of the time.

For example, the machine learning model may receive occurrences including that the user started a new job and that the user is considering having a child. The machine learning model may recognize that the occurrence of starting a new job may have several possible reactions. For example, the user may consider setting up their 401k, taking advantage of employer sponsored health insurance and life insurance, creating a new budget based on a new salary, and taking advantage of a company stock program. The machine learning model may then assess the possible options based on matched user data. The machine learning model may recognize that the user could improve at tracking their spending, so creating a budget may be the most helpful for the user. The machine learning model may also recognize that the company stock program was a significant portion of total compensation for the new job, so the user would benefit from taking advantage of the company stock program as soon as they are able. The machine learning model may recognize that the user is 25 years old and still on their parents’ health insurance, so they may not need the employer-sponsored insurance yet, so enrolling in the employer-sponsored insurance may be less important at the moment. The machine learning model may then recognize that creating a budget, taking advantage of the company stock program, and setting up the user’s 401k may be three possible reactions well-suited to the user’s circumstances and may generate personalized interactive options for those reactions. The machine learning model may be informed that its recognition was correct and may continue training.

In another example, the machine learning model may recognize that the occurrence of the user considering having a child may have several possible reactions. For example, the user may consider saving enough money to adequately support the child, updating their life insurance, opening a 529 plan, updating a will, and preparing their home for the child. The machine learning model may then assess the possible options based on the matched user data. The machine learning model may recognize that the user may have minimal savings, so saving more and adjusting the user’s spending may be an important possible reaction and may be well-suited to the user’s goals and circumstances. The machine learning model may recognize that education is important to the user, so contributing to a 529 plan is another important possible reaction well-suited to the user’s goals and circumstances. The machine learning model may recognize that, because the user wants to have a child but is not yet sure about the timeline, updating the life insurance and the will may be premature. The machine learning model may then recognize that saving money to provide for the child, opening and contributing to the 529 plan, and thinking about making the home more child friendly may be three possible reactions well-suited to the user’s circumstances. So, the machine learning model may generate personalized interactive options for those reactions. The machine learning model may be informed that its recognition was correct and may continue training. In some embodiments, the machine learning model may generate an additional personalized interactive option in response to a user query requesting another personalized interactive option. In some embodiments, the personalized interactive option may be selectable. In some embodiments, selecting the personalized interactive option may initiate an action according to the selection. In some embodiments, the selection of the personalized interactive option may be recorded in a log.

Method 800 may include a step 807 of providing, using the trained machine learning model, a simulated outcome of selecting the personalized interactive option. Upon being presented with the personalized interacting options, the user may engage with each personalized interactive option to learn more about why the personalized interactive model was generated and what the outcome of acting in accordance with the personalized interactive option may be. Using the personalized interactive options provided to the user getting a new job as an example, the machine learning model may use the user’s rent payments, typical spending, and income to provide the user with a sample budget for the user to follow. The machine learning model may simulate the outcome of following the budget by highlighting the user’s total compensation, the user’s income after taxes, and how much money the user may save each year by following the budget. The simulated outcome may include statistics about the financial wellness of users who create and follow their budget.

Method 800 may include a step 808 of delivering a message containing the personalized interactive option and the simulated outcome to a user device. In some embodiments, the message may include a step-by-step explanation of the simulated outcome. In some embodiments, the message may include a visualization of the simulated outcome. In some embodiments, such as in the budget example, the visualization may be a graph or a table with budget values. In some embodiments, the visualization may be, for example, a graphic, a heatmap, a chart, a plot, a simulated user account, or a video clip.

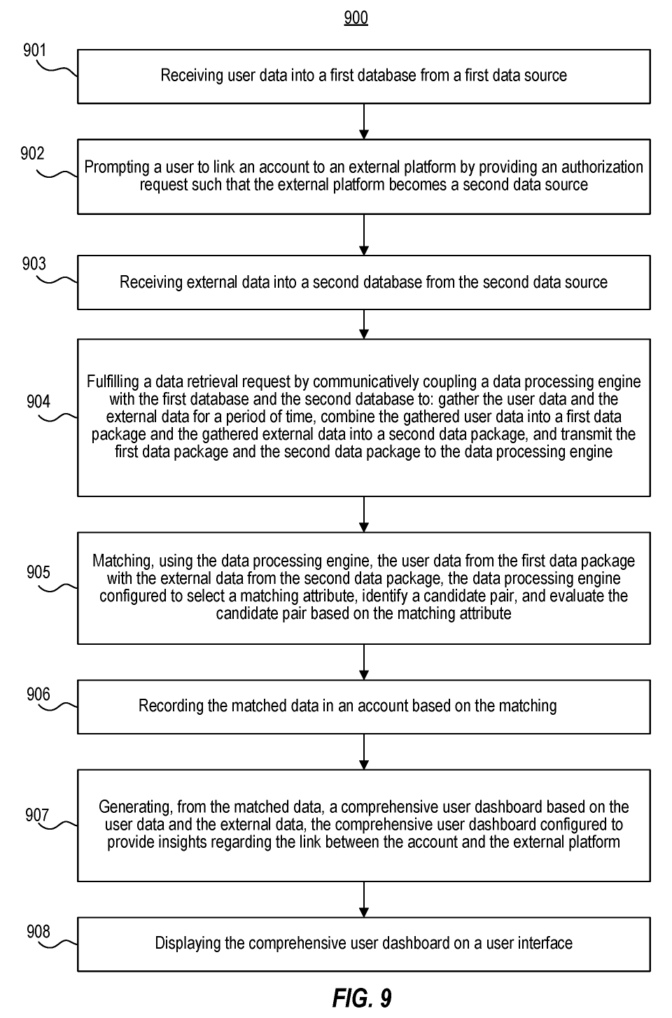

FIG. 9 depicts a flow chart for a method 900 of cross-platform user engagement. Some embodiments pertain to a platform for open banking to get a full picture of a user’s financial situation. Such embodiments may involve a computer system, for example, at a bank or institution, having a platform for open banking to get a full picture of a user’s financial situation.

Method 900 may include a step 901 of receiving user data into a first database from a first data source, as described with respect to FIG. 4. Method 900 may include a step 902 of prompting a user to link an account to an external platform by providing an authorization request such that the external platform becomes a second data source. Authorization request, as described herein, may be a formal mechanism to grant or obtain permission to access, inspect, or receive data or systems from the external platform. In some embodiments, the authorization request may include a proposed scope of access that may be granted to the external platform. The authorization request may define a scope of information to be shared, parties involved, and a duration of access to the shared data or systems. In some embodiments, the authorization request may be sent from the external platform. For example, the authorization request may request that temporary access to the user’s external data be granted to an institution for a period of one month. In some embodiments, the link between the account and the external platform may be terminated after a period of time. In some embodiments, the institution may request external data from several users with the same request. In some embodiments, a third-party that manages the external platform may receive the authorization request on the external platform and may grant or deny the request.

Method 900 may include a step 903 of receiving external data into a second database from the second data source, as described with respect to FIG. 4.

Method 900 may include a step 904 of fulfilling a data retrieval request by communicatively coupling a data processing engine with the first database and the second database, as described with respect to FIG. 4. The data processing engine may be communicatively coupled to the first database and the second database to gather the user data and the external data for a period of time. The data processing engine may be communicatively coupled to the first database and the second database to combine the gathered user data into a first data package and the gathered external data into a second data package. The data processing engine may be communicatively coupled to the first database and the second database to transmit the first data package and the second data package to the data processing engine. In some embodiments, the data retrieval request may retrieve data by data source. In some embodiments, the data retrieval request may retrieve data temporally. In some embodiments, the data retrieval request may retrieve data categorically, such as spending categories, income, and expenses.

Method 900 may include a step 905 of matching, using the data processing engine, the user data from the first data package with the external data from the second data package, as described with respect to FIG. 4. The data processing engine may be configured to select a matching attribute, identify a candidate pair, and evaluate the candidate pair. The evaluation may be based on the matching attribute. Method 900 may include a step 906 of recording the matched data in an account based on the matching, as described with respect to FIG. 4.

Method 900 may include a step 907 of generating, from the matched data, a comprehensive user dashboard based on the user data and the external data, the comprehensive user dashboard configured to provide insights regarding the link between the account and the external platform. In some embodiments, generating the comprehensive user dashboard may involve aggregating the user data and the external data via the data retrieval request and the matching, processing the matched user data through an analytics layer, and visualizing the processed data using business intelligence tools. In some embodiments, the analytics layer may involve a processor configured to analyze the matched user data to produce a performance metric or an insight. In some embodiments, the comprehensive user dashboard may include a performance metric for the external platform. In some embodiments, the performance metric and insight may include, for example, total balance and how the money is divided between accounts, net worth, a budget status, a graph showing income versus expenses over time, a graphic depicting a categorization of expenses, a transaction history, a transfer history between the account and the external platform. In some embodiments, the external platform may be a utility company. In some embodiments, the external data may be utility data associated with the user associated with the account. In some embodiments, the external platform may be an investment company. In some embodiments, the external data may be investment data associated with the user associated with the account. In some embodiments, the external platform may be a lending company. In some embodiments, the external data may be lending data associated with the user associated with the account. In some embodiments, the external platform may be a third-party application. In some embodiments, the external data may be third-party data associated with the user associated with the account. Method 900 may include a step 908 of displaying the comprehensive user dashboard on a user interface. In some embodiments, the user interface of the comprehensive user dashboard may be customizable. In some embodiments, the comprehensive user dashboard may be configured to update in real time as the account and the external platform exchange user data and external data.

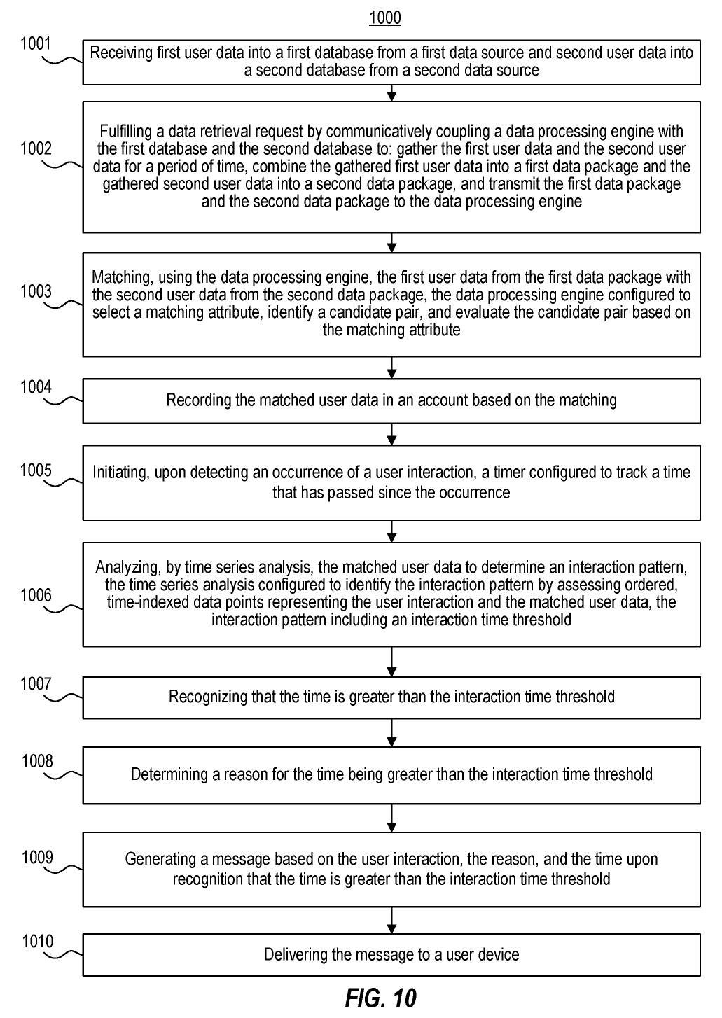

FIG. 10 depicts a flow chart for a method 1000 of promoting user engagement after detecting a break. Some embodiments pertain to detecting a credit card hold and delivering personalized content based on the reason for the hold. Such embodiments may involve a computer system, for example, at a bank or institution, that detects a credit card hold and delivers personalized content based on the reason for the hold.

Method 1000 may include a step 1001 of receiving first user data into a first database from a first data source and second user data into a second database from a second data source, as described with respect to FIG. 4.

Method 1000 may include a step 1002 of fulfilling a data retrieval request by communicatively coupling a data processing engine with the first database and the second database, as described with respect to FIG. 4. The data processing engine may be communicatively coupled to the first database and the second database to gather the first user data and the second user data for a period of time. The data processing engine may be communicatively coupled to the first database and the second database to combine the gathered first user data into a first data package and the gathered second user data into a second data package. The data processing engine may be communicatively coupled to the first database and the second database to transmit the first data package and the second data package to the data processing engine.

Method 1000 may include a step 1003 of matching, using the data processing engine, the first user data from the first data package with the second user data from the second data package, as described with respect to FIG. 4. The data processing engine may be configured to select a matching attribute, identify a candidate pair, and evaluate the candidate pair. The evaluation may be based on the matching attribute. Method 1000 may include a step 1004 of recording the matched user data in an account based on the matching, as described with respect to FIG. 4.

Method 1000 may include a step 1005 of initiating, upon detecting an occurrence of a user interaction, a timer configured to track a time that has passed since the occurrence. In some embodiments, the occurrence may be the user making a purchase using a payment method, such as a credit card. In some embodiments, the occurrence may be the user logging into a user account. In some embodiments, the occurrence may be the user purchasing a specific product or service. Method 1000 may include a step 1006 of analyzing, by time series analysis, the matched user data to determine an interaction pattern. The time series analysis may be configured to identify the interaction pattern by assessing ordered, time-indexed data points representing the user interaction and the matched user data. The interaction pattern may include an interaction time threshold. In some embodiments, the interaction pattern may include shopping at a merchant at a regular interval. In some embodiments, the interaction pattern may include using the payment method at a regular interval. In some embodiments, the interaction pattern may include using the payment method for purchasing a specific product. In some embodiments, the interaction time threshold may depend on the user interaction.

Time series analysis, as described herein, may involve evaluating data points collected at consistent, sequential time intervals to identify a trend, cycle, or seasonal pattern. Trend, as described herein, may refer to a direction of data upwards or downwards. Cycle, as described herein, may refer to an unpredictable, long-term fluctuation in the data. Seasonal pattern, as described herein, may refer to a predictable, repeating pattern over a specific interval, such as weekly, monthly, or annually. Time series analysis may allow for forecasting values based on historical data. Forecasting, as described herein, may refer to using historical interaction patterns to predict a future interaction pattern.

In some embodiments, the time series analysis may evaluate various types of user data against time. For example, in some embodiments, the time series analysis may evaluate an account balance against time. In another embodiment, the time series analysis may evaluate a total number of transactions against time. In another embodiment, the time series analysis may evaluate a number of transactions falling into a spending category against time. Spending categories may include, for example, groceries, dining out, entertainment, retail, or travel.

In one example, the user’s account interaction may be analyzed with respect to time to determine an interaction pattern. In analyzing the user’s account interaction over time, it may be determined that the account interaction is trending upwards, has a seasonal pattern of a couple interactions each month on the days the user is paid by their employer, and cycles between the interactions. The analysis may reveal interaction patterns, such as the user’s login habits.

Method 1000 may include a step 1007 of recognizing that the time is greater than the interaction time threshold. An interaction time threshold, as described herein, may refer to an amount of time that may pass after the user’s last user interaction before an event may be triggered.

Method 1000 may include a step 1008 of determining a reason for the time being greater than the interaction time threshold. In some embodiments, determining may involve considering the occurrence of the user interaction and the matched user data. For example, the interaction pattern may be that the user may use Credit Card A daily, but, one month, the time since the user used Credit Card A may be greater than the interaction time threshold. The matched user data may reveal that, while the user stopped using Credit Card A, the user’s application for Credit Card B may have been approved, and the user’s transaction history may show that the user started using Credit Card B shortly after the user stopped using Credit Card A. Thus, the reason for the time since the user using Credit Card A is greater than the interaction time threshold may be that the user began using a different credit card, Credit Card B. In some embodiments, the reason for the time being greater than the interaction time threshold may be that a user received a new credit card. Similarly, determining may involve checking the location of transactions. For example, the interaction pattern may be that the user resides in City A and shops for groceries at Grocery Store B in City B every week, but the time since the user made purchases at Grocery Store B in City B may be greater than the interaction time threshold. The matched user data may reveal that the user may have been making purchases in a different country for several weeks and then making purchases at Grocery Store A in City A. Thus, the matched user data may reveal that the reason for the time being greater than the interaction time threshold may be that the user was on vacation and that, when they returned, Grocery Store B may have opened a second location, Grocery Store A, in City A, which is closer to where the user resides.

Method 1000 may include a step 1009 of generating a message based on the user interaction, the reason, and the time. The message may be generated upon detection that the timer value is greater than the interaction time threshold. In some embodiments, the time may be reset upon detecting the occurrence of the user interaction. In some embodiments, the message may provide suggested user interactions to reset the time. In some embodiments, where the reason for the time being greater than the interaction time threshold may be a user receiving a new credit card, the message may include resources regarding the new credit card Method 1000 may include a step 1010 of delivering the message to a user device.

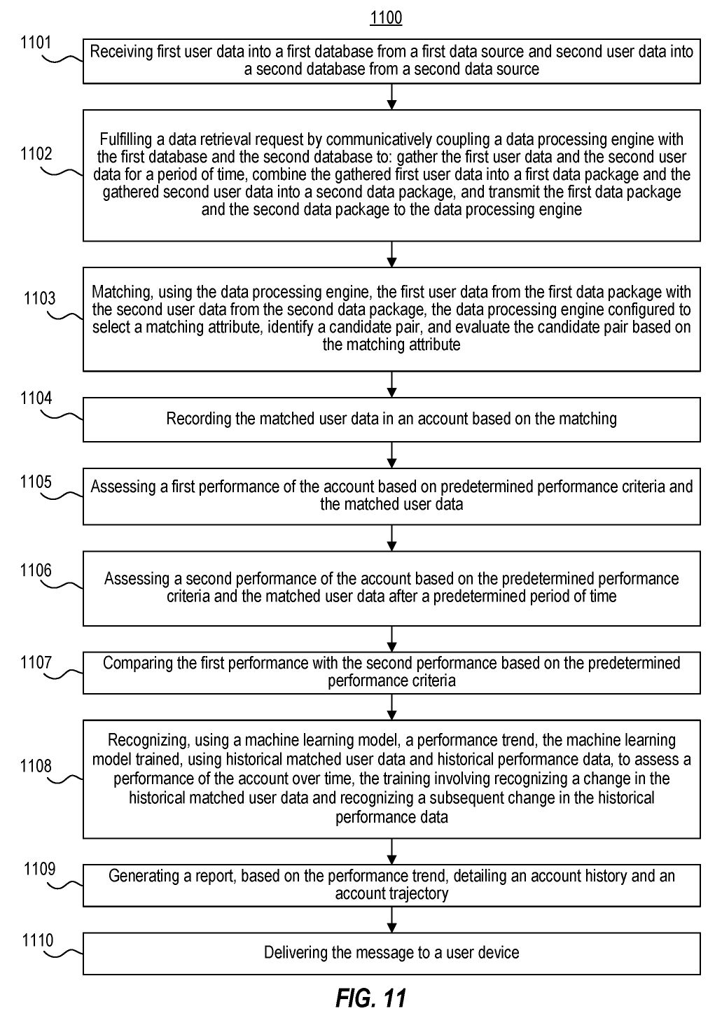

FIG. 11 depicts a flow chart for a method 1100 of analyzing user engagement data. Some embodiments pertain to analyzing user data from a set period of time and generating a report to inform the user where they excelled and where they may improve financially during the next period of time. Such embodiments may involve a computer system, for example, at a bank or institution, that analyzes user data from a set period of time and generates a report to inform the user where they excelled and where they may improve financially during the next period of time.

Method 1100 may include a step 1101 of receiving first user data into a first database from a first data source and second user data into a second database from a second data source, as described with respect to FIG. 4.

Method 1100 may include a step 1102 of fulfilling a data retrieval request by communicatively coupling a data processing engine with the first database and the second database, as described with respect to FIG. 4. The data processing engine may be communicatively coupled to the first database and the second database to gather the first user data and the second user data for a period of time. The data processing engine may be communicatively coupled to the first database and the second database to combine the gathered first user data into a first data package and the gathered second user data into a second data package. The data processing engine may be communicatively coupled to the first database and the second database to transmit the first data package and the second data package to the data processing engine.

Method 1100 may include a step 1103 of matching, using the data processing engine, the first user data from the first data package with the second user data from the second data package, as described with respect to FIG. 4. The data processing engine may be configured to select a matching attribute, identify a candidate pair, and evaluate the candidate pair. The evaluation may be based on the matching attribute. Method 1100 may include a step 1104 of recording the matched user data in an account based on the matching, as described with respect to FIG. 4.

Method 1100 may include a step 1105 of assessing a first performance of the account, as described with respect to FIG. 6. The assessment of the first performance may be based on predetermined performance criteria and the matched user data. Method 1100 may include a step 1106 of assessing a second performance of the account, as described with respect to FIG. 6. Assessment of the second performance may be based on the predetermined performance criteria and the matched user data after a predetermined period of time. In some embodiments, the predetermined period of time may be one month. Method 1100 may include a step 1107 of comparing the first performance with the second performance, as described with respect to FIG. 6. The comparison may be based on the predetermined performance criteria. In some embodiments, comparing the first performance with the second performance may result in a comparison. In some embodiments, the comparison score may be one of either a positive number or a negative number.

Method 1100 may include a step 1108 of recognizing, using a machine learning model, a performance trend. The machine learning model may be trained, using historical matched user data and historical performance data, to assess performance of the account over time. The training may involve recognizing a change in the historical matched user data and recognizing a subsequent change in the historical performance data.

In some embodiments, the machine learning model may be trained using historical matched user data and/or historical performance data. The machine learning model may receive the matched user data, such as a user’s transactions, an account balance, or transfer history. The machine learning model may be trained to recognize a change in the matched user data and then recognize a subsequent change in the performance data. The machine learning model may be trained that changes in the matched user data result in changes in performance, and consistent changes in performance may result in performance trends. For example, the machine learning model may receive matched user data and performance data showing that, after the user met with an institution for advice regarding saving to purchase a home, the user’s savings rate went from 18% of their income during a first month to 21% of their income during a second month and 25% of their income during a third month; and after the user lost their job, their account balance decreased from $43,000 to $32,000 during the first three month of being unemployed.

During training, the machine learning model may be trained that the matched user data showing that after the user met with an institution for advice regarding saving to purchase a home, the user’s savings rate went from 18% of their income during a first month to 21% of their income during a second month and 25% of their income during a third month may represent a change in performance following a change in the matched user data. The machine learning model may recognize that a user’s current goals and/or financial situation may influence their subsequent actions and performance. The matched user data may have changed when the user decided to save to purchase a home. The machine learning model may recognize the user’s meeting with the institution and user’s new goal, which may be noted in an account, and may then recognize the subsequent change in performance of the user’s ravings rate increasing. Since the user’s savings rate steadily increased rather than experiencing a mere fluctuation, the machine learning model may recognize the performance trend of the savings rate increasing.

Similarly, the machine learning model may be trained that the matched user data showing that, after the user lost their job, their account balance decreased from $43,000 to $32,000 during the first three month of being unemployed may represent a change in performance following a change in the matched user data. The machine learning model may recognize that a user’s current goals and/or financial situation may influence their subsequent actions and performance. When the user lost their job, their income may have been lower, and a change in income may be a change in the matched user data. The machine learning model may recognize the change in income as a change in the matched user data and may then recognize the subsequent change in performance of the account balance decreasing from $43,000 to $32,000. The decrease in the account balance may be a change in performance that is a performance trend.

The machine learning model may learn from the examples and go through further training of receiving matched user data, recognizing a change in the matched user data, and recognizing a subsequent change in performance. The recognition may then be confirmed or corrected until the machine learning model is able to make accurate recognitions a threshold amount of the time.

For example, the machine learning model may receive matched user data including that, after giving birth to their first child, the user’s savings rate decreased from 25% to 16%; and after the user moved to a new city, the user’s account balance decreased from $36,000 to $30,000 and then increased to $34,500 within a two-month period. The machine learning model may recognize that the user giving birth and having a new dependent may be a change in the matched user data. The machine learning model may then recognize that the user’s savings rate decreasing from 25% to 16% after having the child may be a change in performance, and the machine learning model may recognize that a decreasing savings rate is a performance trend following a change in the matched user data. The machine learning model may be informed that its determination was correct and may continue training.

In another example, the machine learning model may recognize that the user moving to a new city may be a change in the matched user data, and the user’s account balance fluctuating from $36,000 to $30,000 to $34,500 within a two-month period after moving to a new city may be a change in performance. The machine learning model may then recognize the change in performance of the account balance fluctuating may be a performance trend. The machine learning model may be informed that its determination was incorrect. The machine learning model may be corrected and taught that not every change in performance following a change in the matched user data may be a performance trend. The machine learning model may learn that fluctuations in performance may not be considered a trend, but that consistent change in performance in a direction may be a performance trend. The machine learning model may then continue training.

Method 1100 may include a step 1109 of generating a report based on the performance trend. The report may detail an account history and an account trajectory. In some embodiments, the performance trend may be recorded in a performance log. In some embodiments, the report may include the performance log. In some embodiments, the report may include a performance visual, such as, for example, a chart, a table, a graphic, or a graph. The report may detail the changes in the matched user data leading to the changes in performance. The report may note appearing performance trends and may distinguish the performance trends from fluctuations in performance. The report may indicate whether the performance trends may be positive, negative, or neutral.

In some embodiments, the report may identify a key action where a user associated with the first user data and the second user data may have excelled. In some embodiments, the report may identify a key action where the user may need improvement. In some embodiments, the report may include an insight or metric from a previous time. In some embodiments, the report may contain a third performance based on the predetermined performance criteria and the matched user data at the previous time. In some embodiments, the report may be a formal or informal document, presenting factual information, analysis, or recommendations to aid in future decision making. In some embodiments, the report may have a predefined format, such as a spreadsheet or a memorandum. In some embodiments, the report may be stored on the account and updated continuously. Method 1100 may include a step 1110 of delivering the report to a user device.

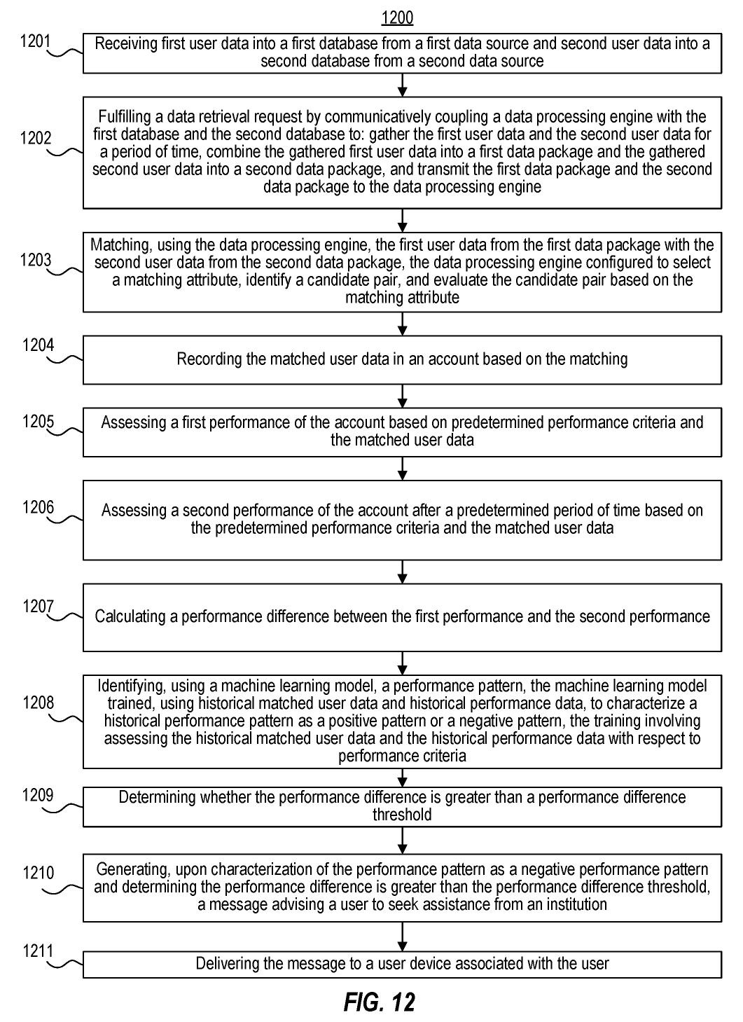

FIG. 12 depicts a flow chart for a method 1200 of recognizing a need. Some embodiments pertain to identifying risk factors indicating that a user is struggling financially and pushing a notification to the user to offer assistance of the institution. Such embodiments may involve a computer system, for example, at a bank or institution, that identifies risk factors indicating that a user is struggling financially and pushing a notification to the user to offer assistance of the institution.

Method 1200 may include a step 1201 of receiving first user data into a first database from a first data source and second user data into a second database from a second data source, as described with respect to FIG. 4.

Method 1200 may include a step 1202 of fulfilling a data retrieval request by communicatively coupling a data processing engine with the first database and the second database, as described with respect to FIG. 4. The data processing engine may be communicatively coupled to the first database and the second database to gather the first user data and the second user data for a period of time. The data processing engine may be communicatively coupled to the first database and the second database to combine the gathered first user data into a first data package and the gathered second user data into a second data package. The data processing engine may be communicatively coupled to the first database and the second database to transmit the first data package and the second data package to the data processing engine.

Method 1200 may include a step 1203 of matching, using the data processing engine, the first user data from the first data package with the second user data from the second data package, as described with respect to FIG. 4. The data processing engine may be configured to select a matching attribute, identify a candidate pair, and evaluate the candidate pair. The evaluation may be based on the matching attribute. Method 1200 may include a step 1204 of recording the matched user data in an account based on the matching, as described with respect to FIG. 4.

Method 1200 may include a step 1205 of assessing a first performance of the account, as described with respect to FIG. 6. The assessment of the first performance may be based on predetermined performance criteria and the matched user data. Method 1200 may include a step 1206 of assessing a second performance of the account after a predetermined period of time, as described with respect to FIG. 6. The assessment of the second performance may be based on the predetermined performance criteria and the matched user data. Method 1200 may include a step 1207 of calculating a performance difference between the first performance and the second performance. In some embodiments, calculating a performance difference between the first performance and the second performance may involve comparing the first performance with the second performance, as described with respect to FIG. 6.

Method 1200 may include a step 1208 of identifying, using a machine learning model, a performance pattern. The machine learning model may be trained, using historical matched user data and historical performance data, to characterize a historical pattern as a positive pattern or a negative pattern. The training may involve assessing the historical matched user data and the historical performance data with respect to performance criteria.

In some embodiments, the machine learning model may be trained using historical matched user data and/or historical performance data. The machine learning model may receive the matched user data, such as a user’s transactions, an account balance, or transfer history. The machine learning model may be trained to identify a performance pattern in the matched user data and characterize the pattern as a positive pattern or a negative pattern. The machine learning model may be trained that consistency in the direction that performance changes may be a performance pattern, and that consistent increases in performance may be indicative of a positive pattern, while consistent decreases in performance may be indicative of a negative pattern. For example, the machine learning model may receive matched user data showing that the user paid their credit card balance after the due date every month for the last five months, and the user’s savings rate has increased by 2% each month for the last four months.

During training, the machine learning model may be trained that the matched user data showing that the user paid their credit card statement after the due date every month for the last five months may indicate a performance pattern of late payments. The machine learning model may identify that a repeated failure to pay a credit card balance by the due date may be a performance pattern, may identify that making late payments hurt account performance because it results in penalties and owing interest, and may characterize the performance pattern as a negative pattern.

Similarly, the machine learning model may be trained that the matched user data showing that user’s savings rate increased by 2% each month for the last four months may indicate a performance pattern of increased savings resulting in the user meeting their financial goals faster. The machine learning model may identify that consistent increases to the user’s savings rate may be a performance pattern and increased savings and savings rate benefits account performance by tending to increase a savings account’s balance. The machine learning model may then characterize the performance pattern as a positive pattern.

The machine learning model may learn from the examples and go through further training of receiving matched user data, identifying a performance pattern, and characterizing the performance pattern as a positive pattern or a negative pattern. The identification and characterization may then be confirmed or corrected until the machine learning model is able to make accurate detections a threshold amount of the time.

For example, the machine learning model may receive matched user data including that the user’s annual income has increased by 5% every year for the last three years and the user’s savings rate has stayed the same. The machine learning model may identify that the user increasing their income by 5% every year may be a performance pattern and increases in income may benefit performance. The machine learning model may then characterize the performance pattern as a positive pattern. The machine learning model may also identify the user’s savings rate remaining constant as being consistent behavior in the matched user data and therefore may be a performance pattern. The machine learning model may recognize that the user shifting their lifestyle proportionally with their income could be a positive pattern or a negative pattern depending on their goals. If, for example, the user has $50,000 saved, has an income of $140,000, and wants to save another $50,000 by the end of the year, then the machine learning model may characterize the user maintaining their savings rate despite the income increase as a negative pattern because the user could be saving more effectively. The machine learning model may be informed that its determination was correct and may continue training.

Method 1200 may include a step 1209 of determining whether the performance difference is greater than a performance difference threshold. In some embodiments, the performance difference threshold may be based on a risk tolerance. In some embodiments, the performance difference threshold may be based on a user goal, such as, for example, achieving a savings goal or savings rate, reaching a specific income level, purchasing a house, or starting a family. In some embodiments, the performance difference threshold may be based on an average financial state of like-users. For example, the user may be 25 years old and has $50,000 saved, and other 25-year-olds may, on average, have $75,000 saved.

Method 1200 may include a step 1210 of generating a message advising a user to seek assistance from an institution. The message may be generated upon characterization of the performance pattern as a negative performance pattern and determining the performance difference is greater than the performance difference threshold. In some embodiments, the message may include a risk factor based on the performance difference. In some embodiments, the risk factor may be one of low risk, medium risk, or high risk. In some embodiments, the message may include an improvement plan tailored to the risk factor. In some embodiments, the improvement plan may include financial wellness resources. In some embodiments, the message may include a tip related to the performance pattern. In some embodiments, upon detecting that the message has been opened, a query may be delivered to the user device to request the user input a helpfulness level of the tip. Method 1200 may include a step 1211 of delivering the message to a user device associated with the user.

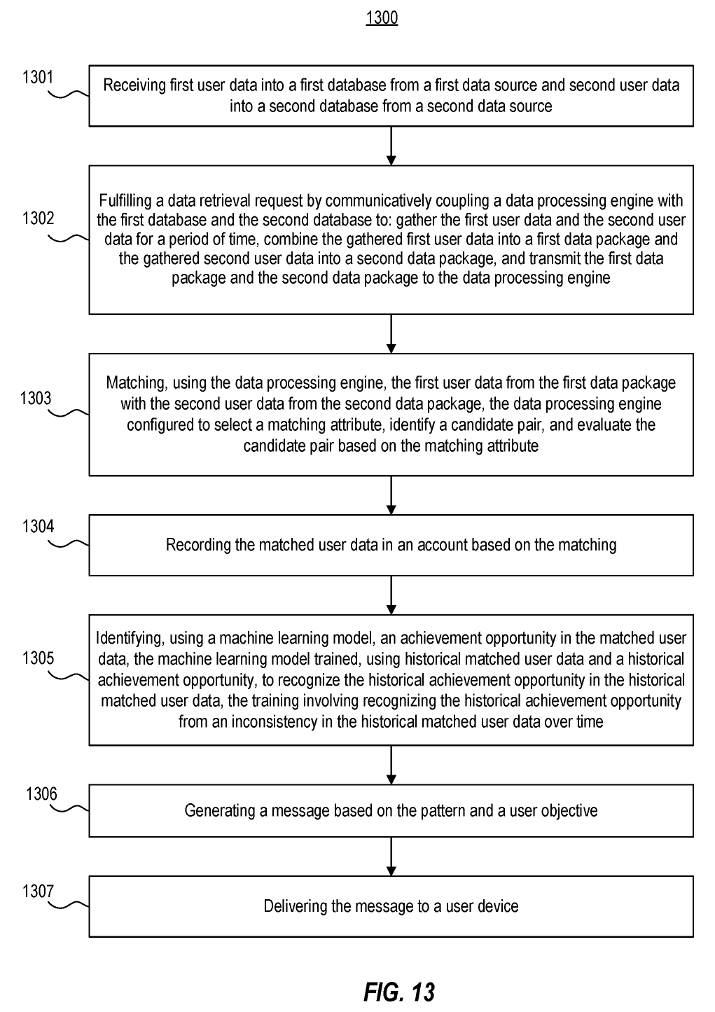

FIG. 13 depicts a flow chart for a 1300 of identifying opportunity. Some embodiments pertain to identifying a user’s savings opportunities. Such embodiments may involve a computer system, for example, at a bank or institution, that identifies a user’s savings opportunities.

Method 1300 may include a step 1301 of receiving first user data into a first database from a first data source and second user data into a second database from a second data source, as described with respect to FIG. 4.

Method 1300 may include a step 1302 of fulfilling a data retrieval request by communicatively coupling a data processing engine with the first database and the second database, as described with respect to FIG. 4. The data processing engine may be communicatively coupled to the first database and the second database to gather the first user data and the second user data for a period of time. The data processing engine may be communicatively coupled to the first database and the second database to combine the gathered first user data into a first data package and the gathered second user data into a second data package. The data processing engine may be communicatively coupled to the first database and the second database to transmit the first data package and the second data package to the data processing engine.

Method 1300 may include a step 1303 of matching, using the data processing engine, the first user data from the first data package with the second user data from the second data package, as described with respect to FIG. 4. The data processing engine may be configured to select a matching attribute, identify a candidate pair, and evaluate the candidate pair. The evaluation may be based on the matching attribute. Method 1300 may include a step 1304 of recording the matched user data in an account based on the matching, as described with respect to FIG. 4.

Method 1300 may include a step 1305 of identifying, using a machine learning model, an achievement opportunity in the matched user data. The machine learning model may be trained, using historical matched user data and a historical achievement opportunity, to recognize the historical achievement opportunity in the historical matched user data. The training may involve recognizing the historical achievement opportunity from an inconsistency in the historical matched user data over time. In some embodiments, the achievement opportunity includes a pay date. The pay date may be flagged as an opportunity to save money. In some embodiments, the achievement opportunity may include a spending category. For example, the achievement opportunity may include an opportunity to spend less on utilities or rent. In some embodiments, identifying the achievement opportunity may include comparing like-payments of similarly situated users. For example, identifying the achievement opportunity may include recognizing that the user pays more for car insurance than other drivers the user’s age with similar vehicles and driving records.

In some embodiments, the machine learning model may be trained using historical matched user data. The machine learning model may be trained to identify the achievement opportunity, such as an opportunity to improve account performance or save money. The machine learning model may be trained that opportunities to save and grow financially may be found in numerous sources. For example, the machine learning model may receive matched user data showing that the user bought a house five years ago, interest rates are lower now, and the user has not refinanced their mortgage; and that the user spends $100 on electricity each month but, on average, the user’s neighbors pay $65.

During training, the machine learning model may be trained that the matched user data showing that the user bought a house five years ago, interest rates are lower now, and the user has not refinanced their mortgage presents an opportunity for the user to save money and/or improve their financial situation. The machine learning model may learn that dropping interests rates may indicate that it may be a beneficial time to refinance a mortgage and that refinancing the mortgage may lower monthly payments, reduce an interest rate, shorten a loan term, or allow the user to borrow against the home’s equity, all of which may be beneficial for the user’s financial health. Thus, the machine learning model may identify that the opportunity to refinance may be an achievement opportunity.

Similarly, the machine learning model may be trained that the matched user data showing that the user spends $100 on electricity each month but, on average, the user’s neighbors pay $65 may present an opportunity for the user to save money and/or improve their financial situation. The machine learning model may learn that the user spending more on a product or a service than a similarly situated user may be an opportunity to see how the user can save money. The machine learning model may learn that when a user’s neighbors are paying 35% less on electricity each month, the user may be keeping lights on when they are not in use, and so the user may be informed that turning the lights off is a potential savings opportunity. Thus, the machine learning model may identify that the user spending 35% more than their neighbors on electricity may be an achievement opportunity.

The machine learning model may learn from the examples and go through further training of receiving matched user data identifying the achievement opportunity. The identification may then be confirmed or corrected until the machine learning model is able to make accurate identifications a threshold amount of the time.

For example, the machine learning model may receive matched user data including that the user met their yearly target and expects to receive an end-of-year bonus. The machine learning model may learn that pay dates, especially for bonuses, are may be opportunities for the user to make more aggressive contributions to a savings goal, investment account, retirement account, or loan balance. The machine learning model may identify that the end-of-year bonus is an opportunity to improve the user’s financial health and therefore may identify the end-of-year bonus as an achievement opportunity. The machine learning model may be informed that its determination was correct and may continue training.

Method 1300 may include a step 1306 of generating a message based on the pattern and a user objective. In some embodiments, the user objective may include a savings goal. In some embodiments, the savings goal may include a balance goal and a purpose. In some embodiments, the purpose may be the reason for the savings goal, such as saving money to, for example, pay for a home, a vacation, or a wedding. In some embodiments, the savings goal may be based on a user savings potential. In some embodiments, the user savings potential may be calculated based on an income and expense report generated based on the first user data and the second user data. In some embodiments, the message may include a recommendation for achieving the savings goal. Method 1300 may include a step 1307 of delivering the message to the user.

Unless otherwise defined, all technical and scientific terms used herein have the same meaning as commonly understood by one of ordinary skill in the art. The materials, methods, and examples provided herein are illustrative only and not intended to be limiting.

According to actual instrumentation and equipment of preferred embodiments of the method and system of the present disclosure, several selected steps may be implemented by hardware or by software on any operating system of any firmware, or by a combination thereof. For example, as hardware, selected steps of the disclosure may be implemented as a chip or a circuit. As software or algorithm, selected steps of the disclosure may be implemented as a plurality of software instructions being executed by a computer using any suitable operating system. Selected steps of the method and system of the disclosure may be performed by a data processor, such as a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device,” it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally include a “network” or a “computer network.”

To provide for interaction with a user, the systems and techniques described herein can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back-end component (e.g., as a data server), or that includes a middleware component (e.g., an application server), or that includes a front end component (e.g., a client computer having a graphical user interface or a web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

The block diagrams in the figures illustrate the architecture, organizational entity, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the organizational entity involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

What is claimed is:

1. A system comprising:
a memory storing instructions; and
a processor configured to execute the stored instructions to:
receive first user data into a first database from a first data source and second user data into a second database from a second data source;
fulfill a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
match, using the data processing engine, the first user data from the first data package with the second user data from the second data package, the data processing engine configured to select a matching attribute, identify a candidate pair, and evaluate the candidate pair based on the matching attribute;
record the matched user data in an account based on the matching;
detect, using a machine learning model, an occurrence of an atypical event in the matched user data, the machine learning model trained, using historical matched user data, to recognize a variation indicating a historical atypical event in the historical matched user data over time, the training involving assessing the variation according to a predetermined variance criteria;
generate a message upon detection of the atypical event to prompt user engagement; and
deliver the message to a user device.

2. The system of claim 1, wherein the atypical event is a deposit that is greater than a preselected growth threshold.

3. The system of claim 1, wherein the atypical event is a withdrawal that is greater than a preselected loss threshold.

4. The system of claim 1, wherein the atypical event is a payment that is greater than a preselected spend threshold.

5. The system of claim 1, wherein the atypical event is a change in a savings rate that is greater than a preselected savings threshold.

6. The system of claim 1, wherein the matched user data includes a first account balance and a second account balance.

7. The system of claim 6, wherein the atypical event is the second account balance being less than the first account balance.

8. The system of claim 1, wherein the atypical event is classified as indicative of one of risk, need, or opportunity.

9. The system of claim 8, wherein the message is tailored based on the classification.

10. The system of claim 1, wherein the atypical event is recorded in an atypical event log, and the atypical event log is used to retrain the machine learning model.

11. A computer implemented method comprising the following operations performed by a processor:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording the matched user data in an account based on the matching;
detecting, using a machine learning model, an occurrence of an atypical event in the matched user data, the machine learning model trained, using historical matched user data, to recognize a variation indicating a historical atypical event in the historical matched user data over time, the training involving assessing the variation according to a predetermined variance criteria;
generating a message upon detection of the atypical event to prompt user engagement; and
delivering the message to a user device.

12. The method of claim 11, wherein the atypical event is a deposit that exceeds a preselected growth threshold.

13. The method of claim 11, wherein the atypical event is a withdrawal that exceeds a preselected loss threshold.

14. The method of claim 11, wherein the atypical event is a payment that exceeds a preselected spend threshold.

15. The method of claim 11, wherein the atypical event is a change in a savings rate that exceeds a preselected savings threshold.

16. The method of claim 11, wherein the matched user data includes a first account balance and a second account balance.

17. The method of claim 16, wherein the atypical event is the second account balance being less than the first account balance.

18. The method of claim 11, wherein the atypical event is classified as indicative of one of risk, need, or opportunity.

19. The method of claim 18, wherein the message is tailored based on the classification.

20. A non-transitory computer storage medium encoded with computer program instructions that when executed by a processor, cause the processor to perform operations comprising:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording the matched user data in an account based on the matching;
detecting, using a machine learning model, an occurrence of an atypical event in the matched user data, the machine learning model trained, using historical matched user data, to recognize a variation indicating a historical atypical event in the historical matched user data over time, the training involving assessing the variation according to a predetermined variance criteria;
generating a message upon detection of the atypical event to prompt user engagement; and
delivering the message to a user device.

21. A computer implemented method comprising the following operations performed by a processor:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording the matched user data in an account based on the matching;
identifying, using a machine learning model, a pattern in the matched user data, the machine learning model trained, using historical matched user data, to recognize the historical matched user data as having a positive pattern or a negative pattern, the training involving recognizing a repeating instance of activity in the historical matched user data over time;
evaluating the pattern with respect to a predetermined standard, where the predetermined standard selected for the evaluation is informed by a user input;
generating a message based on the evaluation, the message advising a user to take a proposed action; and
delivering the message to a user device.

22. The method of claim 21, wherein the pattern includes an increase in a savings rate that is evaluated with respect to a savings expectation.

23. The method of claim 21, wherein the pattern includes a decrease in a savings rate that is evaluated with respect to a savings expectation.

24. The method of claim 21, wherein the message includes a reminder for the user to update the user input.

25. The method of claim 21, wherein the predetermined standard is related to a user attribute in a user profile.

26. The method of claim 25, wherein the message includes a prompt to improve the evaluation based on a user attribute not yet associated with the user profile.

27. The method of claim 21, wherein the predetermined standard is related to goals input by the user.

28. The method of claim 21, wherein the predetermined standard is related to an average financial state of like-users.

29. The method of claim 21, wherein the message includes an option to automatically execute the proposed action.

30. The method of claim 21, wherein the message further includes a proposed goal.

31. A computer implemented method comprising the following operations performed by a processor:
receiving first user data into a first database from a first data source and second user data into a second database from a second data source;
fulfilling a first data retrieval request for a first period of time by communicatively coupling a data processing engine with the first database and the second database to:
gather the first user data and the second user data user data,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording first matched user data in an account based on the matching;
assessing a first performance of the account based on predetermined performance criteria and the first matched user data from the first period of time;
fulfilling a second data retrieval request for a second period of time;
matching, using the data processing engine, the first user data from the first data package with the second user data from the second data package;
recording second matched user data in the account based on the matching;
detecting an occurrence of an event in the second matched user data during the second period of time;
assessing a second performance of the account, based on the predetermined performance criteria and the second matched user data from the second period of time;
comparing the first performance with the second performance based on the predetermined performance criteria;
detecting, using a machine learning model, a change in performance resulting from the occurrence, the machine learning model trained, using historical matched user data, historical first performances, and historical second performances, to recognize an impact of user activity on performance;
generating a message based on the change in performance; and
delivering the message to a user device.

32. The method of claim 31, wherein comparing the first performance with the second performance results in a comparison score that is included in the message as a quantitative measure of the change in performance.

33. The method of claim 32, wherein the comparison score is one of either a positive number or a negative number.

34. The method of claim 33, wherein the change in performance is based on the comparison score.

35. The method of claim 33, wherein the message includes an update on a financial wellness status following the occurrence.

36. The method of claim 31, wherein the first period of time and the second period of time are consecutive.

37. The method of claim 31, wherein the first period of time and the second period of time are each one month.

38. The method of claim 31, wherein the change in performance is recorded in a performance log.

39. A computer implemented method comprising the following operations performed by a processor:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording first matched user data in a first account and second matched user data in a second account based on the matching;
detecting an occurrence of a user milestone impacting the first account and the second account;
assessing, upon detecting the occurrence, a first performance of the first account to determine a first account state, the assessment based on predetermined performance criteria, the matched user data, a first user attribute, and the user milestone;
assessing, upon detecting the occurrence a second performance of the second account to determine a second account state, the assessment based on the predetermined performance criteria, the matched user data, a second user attribute, and the user milestone;
differentiating, using a machine learning model, the first account state and the second account state, the machine learning model trained, using historical user milestones, historical first account state, and historical second account state, to recognize differences in the historical first account state and the historical second account state, the training involving assessing an impact of the historical user milestone on the historical first account state and the historical second account state;
generating a first message based on the first account state and the differentiation;
generating a second message based on the second account state and the differentiation; and
delivering the first message to the first account and the second message to the second account.

40. The method of claim 39, wherein the first message is different from the second message.

41. The method of claim 40, wherein the first message advises why the first message contains a first recommended action different from a second recommended action in the second message.

42. The method of claim 40, wherein the first message includes a list of possible actions and a first recommended action from the list of possible actions, the second message includes the list of possible actions and a second recommended action from the list of possible actions, and the first recommended action is different from the second recommended action.

43. A computer implemented method comprising the following operations performed by a processor:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording the matched user data in an account based on the matching;
detecting, using a rules-based engine, an occurrence of an event in the matched user data, the rules-based engine configured to evaluate the matched user data against a set of predefined event rules;
determining, using a machine learning model and upon detection of the occurrence, a personalized interactive option based on the evaluation, the machine learning model trained, using historical matched user data, a historical occurrence, and historical personalized interactive options, to generate historical personalized interactive options based on the historical occurrence, the training involving recognizing, from the historical matched user data, possible reactions to the historical occurrence and assessing an outcome of the possible reactions to provide, as historical personalized interactive options, the possible reactions with the outcome that addresses the historical occurrence;
providing, using the trained machine learning model, a simulated outcome of selecting the personalized interactive option; and
delivering a message containing the personalized interactive option and the simulated outcome to a user device.

44. The method of claim 43, wherein the system generates an additional personalized interactive option in response to a user query.

45. The method of claim 43, wherein the message includes a step-by-step explanation of the simulated outcome.

46. The method of claim 43, wherein the message includes a visualization of the simulated outcome.

47. The method of claim 43, wherein the personalized interactive option is selectable, and selecting the personalized interactive option initiates an action according to the selection.

48. The method of claim 47, wherein the selection is recorded in a log.

49. A computer implemented method comprising the following operations performed by a processor:
receiving user data into a first database from a first data source;
prompting a user to link an account to an external platform by providing an authorization request such that the external platform becomes a second data source;
receiving external data into a second database from the second data source;
fulfilling a data retrieval request by communicatively coupling a data processing engine with the first database and the second database to:
gather the user data and the external data for a period of time,
combine the gathered user data into a first data package and the gathered external data into a second data package, and
transmit the first data package and the second data package to the data processing engine;
matching, using the data processing engine, the user data from the first data package with the external data from the second data package, the data processing engine configured to select a matching attribute, identify a candidate pair, and evaluate the candidate pair based on the matching attribute;
recording the matched data in an account based on the matching;
generating, from the matched data, a comprehensive user dashboard based on the user data and the external data, the comprehensive user dashboard configured to provide insights regarding the link between the account and the external platform; and
displaying the comprehensive user dashboard on a user interface.

50. The method of claim 49, wherein the external platform is a utility company, and the external data is utility data associated with a user associated with the account.

51. The method of claim 49, wherein the external platform is an investment company, and the external data is investment data associated with a user associated with the account.

52. The method of claim 49, wherein the external platform is a lending company, and the external data is lending data associated with a user associated with the account.

53. The method of claim 49, wherein the external platform is a third-party application, and the external data is third-party data associated with a user associated with the account.

54. The method of claim 49, wherein the link between the account and the external platform is terminated after a period of time.

55. The method of claim 49, wherein the authorization request includes a proposed scope of access that will be granted to the external platform.

56. The method of claim 49, wherein the comprehensive user dashboard includes a performance metric for the external platform.

57. The method of claim 49, wherein the user interface of the comprehensive user dashboard is customizable.

58. The method of claim 49, wherein the comprehensive user dashboard is configured to update in real time as the account and the external platform exchange user data and external data.

59. A computer implemented method comprising the following operations performed by a processor:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording the matched user data in an account based on the matching;
initiating, upon detecting an occurrence of a user interaction, a timer configured to track a time that has passed since the occurrence;
analyzing, by time series analysis, the matched user data to determine an interaction pattern, the time series analysis configured to identify the interaction pattern by assessing ordered, time-indexed data points representing the user interaction and the matched user data, the interaction pattern including an interaction time threshold;
recognizing that the time is greater than the interaction time threshold;
determining a reason for the time being greater than the interaction time threshold;
generating a message based on the user interaction, the reason, and the time upon recognition that the time is greater than the interaction time threshold; and
delivering the message to a user device.

60. The method of claim 59, wherein the interaction pattern includes shopping at a merchant at a regular interval.

61. The method of claim 59, wherein the interaction pattern includes using a payment method at a regular interval.

62. The method of claim 59, wherein the interaction pattern includes using a payment method for purchasing a specific product.

63. The method of claim 59, wherein the interaction time threshold depends on the user interaction.

64. The method of claim 59, wherein the time is reset upon detecting the occurrence of the user interaction.

65. The method of claim 64, wherein the message provides suggested user interactions to reset the time.

66. The method of claim 59, wherein the reason for the time being greater than the interaction time threshold is a user receiving a new credit card.

67. The method of claim 66, wherein the message includes resources regarding the new credit card.

68. A computer implemented method comprising the following operations performed by a processor:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording the matched user data in an account based on the matching;
assessing a first performance of the account based on predetermined performance criteria and the matched user data;
assessing a second performance of the account based on the predetermined performance criteria and the matched user data after a predetermined period of time;
comparing the first performance with the second performance based on the predetermined performance criteria;
recognizing, using a machine learning model, a performance trend, the machine learning model trained, using historical matched user data and historical performance data, to assess a performance of the account over time, the training involving recognizing a change in the historical matched user data and then recognizing a subsequent change in the historical performance data;
generating a report, based on the performance trend, detailing an account history and an account trajectory; and
delivering the report to a user device.

69. The method of claim 68, wherein the predetermined period of time is one month.

70. The method of claim 68, wherein comparing the first performance with the second performance results in a comparison score included in the report.

71. The method of claim 70, wherein the comparison score is one of either a positive number or a negative number.

72. The method of claim 68, wherein the performance trend is recorded in a performance log included in the report.

73. The method of claim 68, wherein the report contains a third performance based on the predetermined performance criteria and the matched user data at a previous time..

74. The method of claim 68, wherein the reports includes a performance visual.

75. The method of claim 68, wherein the report identifies a key action where a user associated with the first user data and the second user data excelled and a key action where the user needs improvement.

76. The method of claim 68, wherein the report is stored on the account and updated continuously.

77. A computer implemented method comprising the following operations performed by a processor:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package, and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording the matched user data in an account based on the matching;
assessing a first performance of the account based on predetermined performance criteria and the matched user data;
assessing a second performance of the account after a predetermined period of time based on the predetermined performance criteria and the matched user data;
calculating a performance difference between the first performance and the second performance;
identifying, using a machine learning model, a performance pattern, the machine learning model trained, using historical matched user data and historical performance data, to characterize a historical performance pattern as a positive pattern or a negative pattern, the training involving assessing the historical matched user data and the historical performance data with respect to performance criteria;
determining whether the performance difference is greater than a performance difference threshold;
generating, upon characterization of the performance pattern as a negative performance pattern and determining that the performance difference is greater than the performance difference threshold, a message advising a user to seek assistance from an institution; and
delivering the message to a user device associated with the user.

78. The method of claim 77, wherein the message includes a risk factor based on the performance difference.

79. The method of claim 78, wherein the risk factor is one of low risk, medium risk, or high risk.

80. The method of claim 78, wherein the message includes an improvement plan tailored to the risk factor.

81. The method of claim 80, wherein the improvement plan includes financial wellness resources.

82. The method of claim 77, wherein the performance difference threshold is based on a risk tolerance.

83. The method of claim 77, wherein the performance difference threshold is based on a user goal.

84. The method of claim 77, wherein the performance difference threshold is based on an average financial state of like-users.

85. The method of claim 77, wherein the message includes a tip related to the performance pattern.

86. The method of claim 85, wherein, upon detecting that the message has been opened, a query is delivered to the user device to request the user input a helpfulness level of the tip.

87. A computer implemented method comprising the following operations performed by a processor:
receiving first user data into a first database from a first data source and second user data into a second database from a second data source;
fulfilling a data retrieval request by communicatively coupling a data processing engine with the first database and the second database to:
gather the first user data and the second user data for a period of time,
combine the gathered first user data into a first data package and the gathered second user data into a second data package; and
transmit the first data package and the second data package to the data processing engine;
matching, using the data processing engine, the first user data from the first data package with the second user data from the second data package, the data processing engine configured to select a matching attribute, identify a candidate pair, and evaluate the candidate pair based on the matching attribute;
recording the matched user data in an account based on the matching;
identifying, using a machine learning model, an achievement opportunity in the matched user data, the machine learning model trained, using historical matched user data and a historical achievement opportunity, to recognize the historical achievement opportunity in the historical matched user data, the training involving recognizing the historical achievement opportunity from an inconsistency in the historical matched user data over time;
generating a message based on the achievement opportunity and a user objective; and
delivering the message to a user device.

88. The method of claim 87, wherein the user objective includes a savings goal.

89. The method of claim 88, wherein the savings goal includes a balance goal and a purpose.

90. The method of claim 88, wherein the savings goal is based on a user savings potential calculated based on an income and expense report generated based on the first user data and the second user data.

91. The method of claim 88, wherein the message includes a recommendation for achieving the savings goal.

92. The method of claim 87, wherein the achievement opportunity includes a pay date.

93. The method of claim 87, wherein the achievement opportunity includes a spending category.

94. The method of claim 93, wherein identifying the achievement opportunity includes comparing like-payments of similarly situated users.

95. The method of claim 94, wherein the message includes a notification that the user is spending more on a service than the similarly situated users.
